(19) United States
(12) Patent Application Publication
(10) Pub. No.: US 2016/0357958 A1
(43) Pub. Date: Dec. 8, 2016

(54) Computer System Security

(71) Applicant: Michael Guidry, Miami, FL (US)

(72) Inventor: Michael Guidry, Miami, FL (US)

(21) Appl. No.: 15/176,726

(22) Filed: Jun. 8, 2016

Related U.S. Application Data
(60) Provisional application No. 62/172,392, filed on Jun. 8, 2015.

(51) Int. Cl. G06F 21/53; G06F 21/55

(52) U.S. Cl. CPC G06F 21/53; G06F 21/554; G06F 2221/2149

(57) ABSTRACT

A security system monitors a computer system for process events to perform verification related to the event. A thread related to an event is identified and a set of software modules of the computer system are enumerated. The thread is verified by determining whether the thread corresponds to one of the software modules. Code related to the thread is verified by loading code segments from storage into memory and comparing newly loaded code with original code segments in memory. The stack is verified by determining whether the thread matches one or more stack addresses of the stack. The execution path related to the event is verified by comparison to a set of predefined execution paths. If any of the security verifications fail, a security event is generated such as by blocking execution of code related to the event.

### CLAIM OF PRIORITY

The present application claims priority from U.S. Provisional Patent Application No. 62/172,392, entitled “COMPUTER SYSTEM SECURITY,” by Michael Guidry, filed Jun. 8, 2015, incorporated by reference herein in its entirety.

### BACKGROUND OF THE INVENTION

The disclosed technology is related to security in computer systems.

A basic computer system comprises computer hardware, an operating system, and one or more application programs. The computer hardware includes a processor, a memory, and one or more system buses that facilitate communication among the various components. The operating system is an interface between applications and the hardware layer of the computer system. The operating system includes various routines that manage the physical components of the computer system and their use by applications.

Computer programs are known to have vulnerabilities to various kinds of attacks. Attacks can be instituted and delivered over network connections such as the Internet, but also may come directly from someone with immediate access to a computer system. Computer viruses, worms, and trojan horses are all examples of different forms of attack. Attacks are generally implemented by installing unauthorized or malicious code into the programs and causing execution of the foreign code. For example, exploits may be created to force an application to execute code after an exploit has been triggered. The code may be considered a payload which is often prepared in memory before being triggered by the exploit.

### BRIEF DESCRIPTION OF THE DRAWINGS

FIG. 1 is a simplified block diagram of a computing device that can be used to implement various embodiments of the disclosed technology.

FIG. 2 is a block diagram of a computing environment including a security system in accordance with one embodiment.

FIG. 3 is a flowchart describing a process of security verification in accordance with one embodiment.

FIG. 4 is a flowchart describing a process of thread verification in accordance with one embodiment.

FIG. 5 is a flowchart describing a process of code verification in accordance with one embodiment.

FIG. 6 is a flowchart describing a process of stack verification in accordance with one embodiment.

FIG. 7 is a flowchart describing a process of execution path verification in accordance with one embodiment.

FIG. 8 is a flowchart describing a process of analyzing an application to define one or more predefined execution paths.

FIG. 9 is a flowchart describing a process of monitoring an application and training a security engine in accordance with one embodiment.

FIG. 10 is a block diagram describing a security engine in accordance with one embodiment.

FIG. 11 is a block diagram of a computing environment including a security system in accordance with one embodiment.

FIG. 12 is a flowchart describing a process of exploit mitigation in accordance with one embodiment.

FIG. 13 is a block diagram describing a process of assembly code modification for automatic vulnerability patching.

FIG. 14 is a flowchart describing a process of modifying assembly code in accordance with one embodiment.

FIG. 15 is a flowchart describing operation of an application or other process modified for heap protection.

FIG. 16 is a flowchart describing operation of an application or process modified for stack protection.

FIG. 17 is a flowchart describing a process of modifying an application's code to provide a checking agent.

FIG. 18 is a flowchart describing operation of a checking agent.

FIG. 19 is a flowchart describing a process of disassembling code to implement a checking function for individual calls in one embodiment.

FIG. 20 is a flowchart describing the operation of the verification agent in one embodiment.

FIG. 21 is a flowchart describing a process of disassembling code to implement a call list agent for an application.

FIG. 22 is a flowchart describing the operation of the call list agent in one embodiment.

### DETAILED DESCRIPTION

A security system and related methods for managing code execution in a computer system are provided. The security system is configured to monitor code execution associated with applications of the computer system to prevent and/or mitigate exploits within software modules. In one embodiment, the security system monitors the computer system for various events and in response to select events performs one or more verifications related to code associated with the event. The security system may respond to an event by performing a security verification including one or more or more of thread verification, code verification, stack verification, and execution path verification related to the event. The security system may identify a thread related to the event and enumerate a set of software modules of the computer system. The thread may be verified by determining whether the thread corresponds to one or more of the software modules. The security system may further verify that the corresponding software module is identified as a legitimate software module. The security system may verify code related to the thread by loading one or more code segments from storage into memory and comparing the newly loaded code with an original code segment in memory that is associated with the event. The stack is verified in one embodiment by determining whether the thread matches one or more stack addresses of the stack. An execution path related to the event is determined and compared with a set of predefined execution paths to verify the execution path. If one or more verification fails, a security event can be generated, such as by blocking execution of code associated with the event and/or generating an indication of the failed verification.

In one embodiment, the security system detects exploits by monitoring each application of the computer system for an entry point, the beginning of each thread within the application, the beginning of co-routines, and other events related to the application. In one implementation, the security system operates with modern operating systems providing a multi-tasking operating system. The security system activates security verification to block malicious activities before code starts in applications, including processes, threads, and co-routines of the application, as well as processes in multi-tasking systems. The security system may be implemented in a kernel, user land, hypervisor, or at the hardware level, as well as using combinations of these implementations.

In one embodiment, the security system includes a security engine. The security engine may be implemented in hardware or software. The security system may include components at the application (user) layer of the computer system and/or components at the operating system or kernel layer. In one embodiment, the security engine injects one or more agents into a software module to be monitored. The software module may be part of an application process. The security engine may inject the agents using application level techniques and/or kernel level techniques. At the application level, the security engine in one embodiment injects one or more security agents into each process of a software module to be monitored. The security agents may comprise a dynamic linked library (DLL), executable (.exe), or other code section that is loaded into the module to be monitored. The security engine may alter a registry of an operating system in one embodiment to list the security agents as a code section such as a DLL that is loaded when the application or software module in the application to be monitored is loaded. In another example, the security engine may include a kernel driver that forcibly injects the one or more agents into each application when the application or software module in the application starts.

In one embodiment, the security agents detect or receive process events such as DLL events, etc. within an application being monitored. The security agent may detect a thread attach/detach process event for example. The security engine may receive an event notification from the security agent in response to event detection. The event can occur on a thread when the thread is created and before execution of the code begins. The security engine and/or agents can read memory associated with a process, thread, or other software module. In one embodiment, an agent may read memory and operate within a process as if it was a native portion of a thread's executive code. In one embodiment, the integrity verification may be called using one or more of an application programming interface, event notifications, and may be different based on different operating systems and whether implemented in a user or kernel level.

In one embodiment, the security system enumerates shared libraries and/or kernel system drivers in response to an event or event notification. The security engine, for example, may determine the executables, DLLs, libraries, drivers, etc. associated with an application being monitored. The security system may identify a specific call and thread identifier associated with the application. The security system can perform thread verification by verifying that one or more addresses and/or libraries associated with the thread match legitimate modules and/or predefined libraries in the system.

In one embodiment, the security system identifies one or more code segments associated with a thread in response to an event in order to perform code verification. The one or more code segments may be loaded in memory as an executing copy of the application being monitored. The security system identifies the one or more code segments in storage, and loads a second copy of the code segments into memory. The security system may then verify that the executing copy of the code matches the newly loaded copy from storage. If the executing copy has been modified by malicious activity, for example, the security system will detect a discrepancy in the copies of the code. In response to a discrepancy, the security system can generate a security event.

The security system in one embodiment performs a verification of the stack in response to a security event as part of security verification. The security system may verify that the thread start address associated with an event is located on the stack. In this manner, a manipulation of the stack to point to a gadget or other malicious code segment can be detected. The thread start address is typically not visible after manipulation of the stack such that the malicious activity can detected. The security system may further verify that the parent calling functions of all functions of the application until the thread start are located on the stack. Moreover, the security system may verify that the code segments in memory for each calling function match a copy of the corresponding code segment loaded from storage.

In one embodiment, the security system implements execution path verification in response to an event. An analysis engine, such as part of the security engine, may analyze an application during a training phase to develop an outline of the application. The outline may list calling functions, jumps, branches, etc. to provide a predefined list of execution paths. In response to an event, the security system may determine an execution path related to the event. The security system compares the execution path with the predefined list of execution paths. If the execution path does not match one or more of the predefined execution paths, the security system can generate a security event.

In one embodiment, process events are rated and the security system responds to events selectively based on the event rating. In response to an event or event notification, the security system determines an event rating associated with the event and responds based on the event rating. A higher rating may indicate a greater potential or association with exploits for the event. The system may only perform the various verifications when the event rating is greater than a threshold, indicating a greater likelihood of an exploit. In one embodiment, the security system performs select ones of the verifications based on the event rating. For example, the security system may perform thread verification when the event rating is above a first threshold, additionally perform code verification when the event rating is above a second threshold, additionally perform stack verification when the event rating is above a third threshold, and additionally perform execution path verification when the event rating is above a fourth threshold. The fourth threshold is greater than the third threshold, the third threshold is greater than the second threshold, and the second threshold is greater than the first threshold. Other implementations using event ratings to selectively perform verification may be used. Furthermore, in one embodiment, each verification may be triggered independently using event ratings or other mechanisms such as direct hooks within the associated code being monitored.

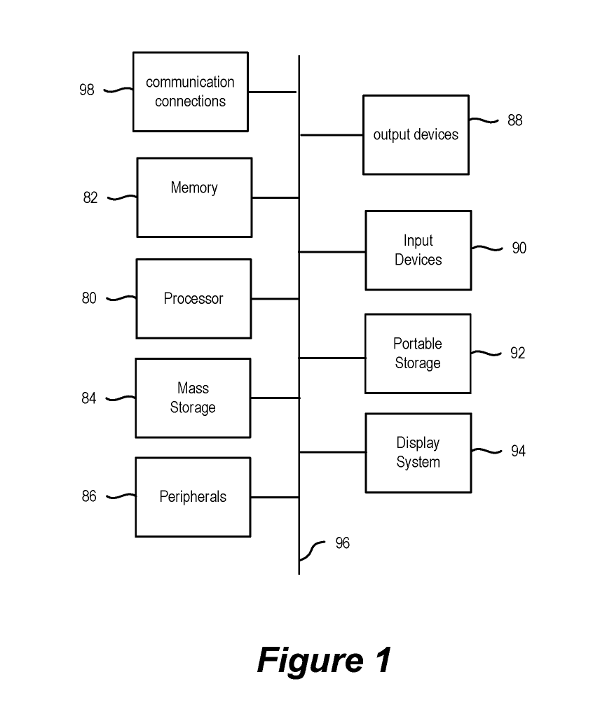

FIG. 1 is a high level block diagram of a computer system 150 in which embodiments of the disclosed technology may be implemented. The computing system of FIG. 1 includes processor 80, memory 82, mass storage device 84, peripherals 86, output devices 88, input devices 90, portable storage 92, and display system 94. For purposes of simplicity, the components shown in FIG. 1 are depicted as being connected via a single bus 96. However, the components may be connected through one or more data transport means. In one alternative, processor 80 and memory 82 may be connected via a local microprocessor bus, and the mass storage device 84, peripheral device 86, portable storage 92 and display system 94 may be connected via one or more input/output buses.

Processor 80 may contain a single microprocessor, or may contain a plurality of microprocessors for configuring the computer system as a multiprocessor system. Memory 82 stores instructions and data for programming processor 80 to implement the technology described herein. In one embodiment, memory 82 may include banks of dynamic random access memory, high speed cache memory, flash memory, other nonvolatile memory, and/or other storage elements. Mass storage device 84, which may be implemented with a magnetic disc drive or optical disc drive, is a nonvolatile storage device for storing data and code. In one embodiment, mass storage device 84 stores the system software that programs processor 80 to implement the technology described herein. Portable storage device 92 operates in conjunction with a portable nonvolatile storage medium, such as a floppy disc, CD-RW, flash memory card/drive, etc., to input and output data and code to and from the computing system of FIG. 1. In one embodiment, system software for implementing embodiments is stored on such a portable medium, and is input to the computer system via portable storage medium drive 92.

Peripheral devices 86 may include any type of computer support device, such as an input/output interface, to add additional functionality to the computer system. For example, peripheral devices 86 may include one or more network interfaces for connecting the computer system to one or more networks, a modem, a router, a wireless communication device, etc. Input devices 90 provide a portion of a user interface, and may include a keyboard or pointing device (e.g. mouse, track ball, etc.). In order to display textual and graphical information, the computing system of FIG. 1 will (optionally) have an output display system 94, which may include a video card and monitor. Output devices 88 can include speakers, printers, network interfaces, etc. Device 100 may also contain communications connection(s) 112 that allow the device to communicate with other devices via a wired or wireless network. Examples of communications connections include network cards for LAN connections, wireless networking cards, modems, etc. The communication connection(s) can include hardware and/or software that enables communication using such protocols as DNS, TCP/IP, UDP/IP, and HTTP/HTTPS, among others.

The components depicted in the computer system of FIG. 1 are those typically found in computing systems suitable for use with the technology described herein, and are intended to represent a broad category of such computer components that are well known in the art. Many different bus configurations, network platforms, operating systems can be used. The technology described herein is not limited to any particular computing system. Other embodiments may not include all of the hardware components shown in FIG. 1 and/or may include additional hardware components to those shown. The computing system can be a personal desktop computer, workstation, server, mini-computer, main frame, laptop computer, handheld computer, mobile computer, cellular telephone, smartphone, television set-top box, or other computing device. Many different bus configurations, network platforms, operating systems can be used. The technology described herein is not limited to any particular computing system.

The technology described herein can be implemented using hardware, software, or a combination of both hardware and software. The software used is stored on one or more of the processor readable storage devices described above (e.g., memory 82, mass storage 84 or portable storage 92) to program one or more of the processors to perform the functions described herein. The processor readable storage devices can include computer readable media such as volatile and non-volatile media, removable and non-removable media. By way of example, and not limitation, computer readable media may comprise computer readable storage media and communication media. Computer readable storage media may be implemented in any method or technology for non-transitory storage of information such as computer readable instructions, data structures, program modules or other data. Examples of computer readable storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other non-transitory medium which can be used to store the desired information and which can be accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as RF and other wireless media. Combinations of any of the above are also included within the scope of computer readable media. Thus, while computer readable communication media includes signals, computer readable storage media does not and only includes non-transitory storage.

In alternative embodiments, some or all of the software can be replaced by dedicated hardware including custom integrated circuits, gate arrays, FPGAs, PLDs, and special purpose computers. In one embodiment, software (stored on a storage device) implementing one or more embodiments is used to program one or more processors. The one or more processors can be in communication with one or more computer readable media/storage devices, peripherals and/or communication interfaces. In alternative embodiments, some or all of the software can be replaced by dedicated hardware including custom integrated circuits, gate arrays, FPGAs, PLDs, and special purpose computers.

One type of malicious software use is referred to as malicious shared libraries. The use of malicious shared libraries is a widely used tactic to manipulate software for malicious reasons such as backdooring, redirecting, etc. While shared libraries have legitimate uses, for example to compress all file input/output, for example, shared libraries are often used in association with malicious computing attacks. “Reflective DLL” injection, also referred to as “CloakDLL” and “DLL hiding,” is an example of a malicious injection technique that is often used in association with the WINDOWS operating system. In the LINUX environment, a variable “LD_PRELOAD” is often used in association with malicious injection techniques. “LD_PRELOAD,” for example, can be used to ensure a shared library is loaded inside of a process. Similarly, the OSX operating system includes an environment variable “DYLD_INSERT_LIBRARIES” which has a similar function. A process may also be forced to load a library after it is executing by attaching to the process using a debugger, for example. A debugging API of an operating system can be used to pause a process. With the process paused, the filename of the shared library can be inserted. The process can then be manipulated to execute the functions related to loading the shared library. After executing the functions, the original state of the process can be restored and the debugger can be detached. The debugger may also be used to directly manipulate and insert code modifications on a target process, or kernel. The “LoadLibrary” is often used with the WINDOWS operating system and “dlopen” is often used with the LINUX operating environment. This function is inside of a linker package and can be called whenever any non-static linked library is loaded into the address space to resolve dependencies much like DLLs in Windows. It is used often for backdooring UNIX (Linux, etc.) processes much like DLL injection is used on WINDOWS. The DYLD function in the OSX system may be used. Most operating systems include functions that operate in a similar manner such that porting to each may be done, including in embedded systems such as routers, etc. Additionally, many UNIX operating systems include a block file in /dev such as mem, or kmem (/dev/kmem/dev/mem) which allow direction manipulation of all memory on the system. In one embodiment, thread verification is performed to detect the use of malicious shared libraries and other malicious activity.

Other malicious activity includes the use of executable compression such as packers that provide techniques for compressing files such as executable files and data. The compressed executable file and compressed data are combined with decompression code into an executable. In some cases, packers such as “Ultimate Packer for eXecutables (UPX)” may allocate memory, even though code has changed since the execution began. UPX, for example, is a free, portable, extendable, high-performance executable packer for several executable formats. Packing techniques may be used to obfuscate malicious activity. In many instances, antivirus techniques are unable to detect a wide variety of malicious software because the software is obfuscated using packing techniques. In one embodiment, code verification is performed to detect the use of packers and other malicious activity.

In return-oriented programming (ROP), exploits are generated by manipulating a call stack to cause execution of individual machine-level instructions. Sequences of these low-level commands are executed in what are commonly referred to as gadgets. Many functions, in C/C++ and other languages, begin with an instruction such as “Push ebp.” These functions generally end with an instruction such as “Pop epb” followed by “Ret.” In many instances, ROP exploits are generated using the instructions just before a return within a given function. Many of the instructions can be grouped together to form ROP gadgets. In one embodiment, code verification is performed to detect the use of ROP exploits and other malicious activity.

A security system is described including a security engine that detects potential exploits by monitoring an application's entry point, beginning of each thread, beginning of co-routines, etc. and generating a security event in response to the detection of an anomaly. Modern operating systems have several different mechanisms that accomplish ideas of a multitasking operating system. Multitasking in a computing environment refers to techniques or methods that enable multiple processes to share processors and other resources of the computing system. Generally, a process in computing environment refers to an instance of a computer program or application that is being executed by a processor of the computing system. A process may include program code and current activity. A process may include one or multiple execution threads that execute instructions at the same time. In a multitasking environment, a processor can switch between different tasks without requiring any of the tasks to complete. Processes typically include multiple software modules which may include any number of drivers, DLLs, executables, or any other type of code section.

One or more verification functions, as part of an security function or checking function for example, can be executed prior to code executing in these processes, including threads, co-routines or other multitasking systems. The security engine including security verification can be implemented in the kernel of a computer system, in the application layer as part of the user land, in a hypervisor, or in the hardware layer of the computer system. The security engine can be triggered to execute before code is executed in these processes, including threads, co-routines or other multitasking systems.

In one embodiment, the security engine injects security agents into one or more applications or processes which monitor the applications and generate event notifications related to particular events within the application. The security engine performs various verifications in response to particular event notifications by performing one or more verifications to verify the integrity of the code to be executed. If the security verification is successful, the code can be released for execution. If the security verification fails, a security event can be generated. The security event may include an alert or other indication of a potential exploit, and/or blocking execution of code related to the security event.

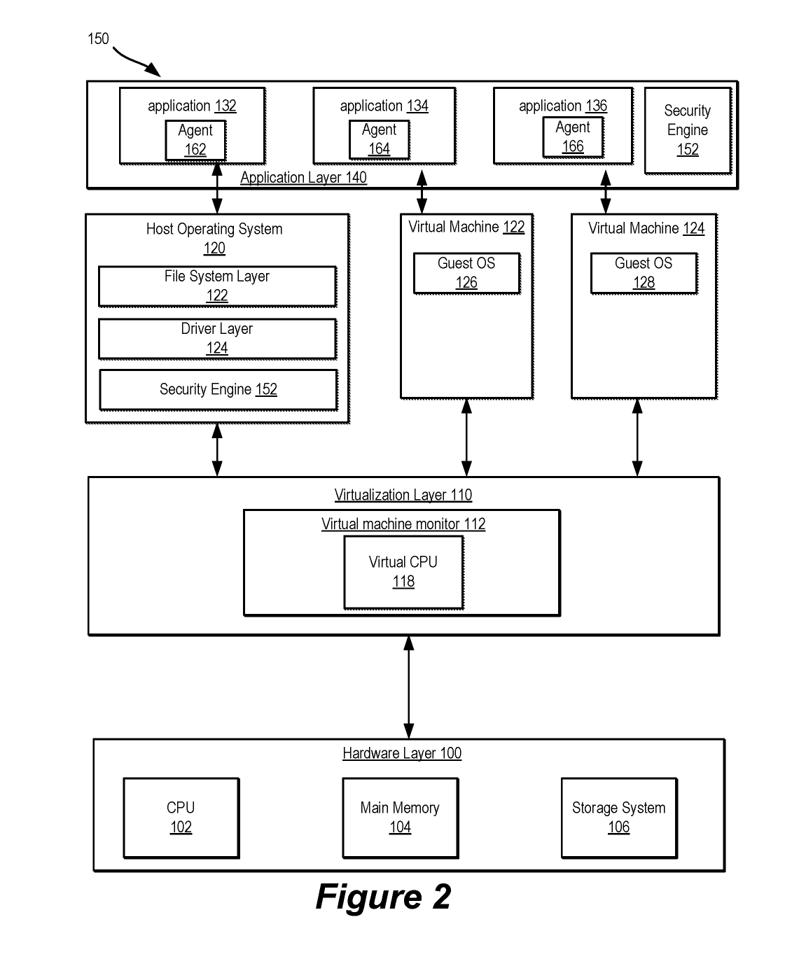

FIG. 2 is a block diagram of a computer system 150 including a security system in accordance with one embodiment of the disclosed technology. The security system provides security features in a computer system including techniques for mitigating system exploits in accordance with one embodiment. In FIG. 2, a hardware layer 100 includes a central processing unit (CPU) 104, a main memory 104, and a storage system 106. The hardware components can be connected via a single bus or through one or more data transport means. The hardware layer may include additional components such as those depicted in FIG. 1.

A host operating system (OS) 120 is implemented for general management of the computer system 150. The operating system interfaces between the hardware layer and an application layer 140 for management of the various physical resources of the computing system. The operating system may include various schedulers, drivers, etc. that allocate usage of CPU to the application layer 140. In FIG. 2, three exemplary applications 136, 132, and 134 are shown for explanatory purposes although any number of applications may be executed by the computing system. Applications 136, 132, and 134 may concurrently be executed by the operating system in the application layer 140. The applications may be in an active executing state whereby CPU processing time is being allocated to a process for each application in one example. The operating system includes resource schedulers that reside between a core kernel layer/file system layer 122 and a driver layer 124 including various hardware drivers for supporting the hardware components coupled to the computing system. The operating system layer includes guest operating systems (OS) 126 and 128 in additional to host operating system 120. The guest operating systems reside in individual domains depicted as virtual machines 122 and 124.

An optional virtualization layer 110 interfaces between hardware layer 100 and the software layers to present the hardware layer to multiple operating systems such that each operating system appears to have direct access to the resources made available to it. The virtualization layer includes a virtual machine monitor 112 (VMM) the enables software applications to run in isolated environments on the shared hardware layer. The VMM itself is a software layer running on the hardware layer that provides an abstraction of the computing system to the software layers. VMM 110 includes virtualized versions of the hardware resources that are shared at the operating system layer. The shared CPU 102 is virtualized and presented to the guest operating systems as virtual CPU 118. The shared storage system 106 and other resources in hardware layer 100 can be virtualized and presented to the guest operating systems also. Other embodiments may not include a virtualization layer.

Computer system 150 includes a security engine 152 that provides protection and mitigation from potential exploits in the computer system 150. Security engine 152 can be implemented in the application layer 140 and/or the host operating system 120 layer. In the application layer 140, the security engine may be referred to as security application or user component. In the operating system 120 layer, the security engine may be referred to as a security kernel component. Security engine 152 is loaded into main memory 104 for execution in the application layer 140 in one embodiment. In another embodiment security engine 152 is loaded into main memory 104 for execution as part of the operating system kernel. As described hereinafter, additional or alternate components of the security system may be implemented in virtualization layer 110, hardware layer 100, or as a custom operating system, for example. Security engine 152 modifies applications 132-136 to include security agents 162, 164, and 166. Agents 162-166 may be inserted into applications 132, 134, and 136 using various techniques. In one example, the agents may be compiled as a shared library, such as a DLL in a Windows Operating Environment, or other library or executable. The security agents include libraries inserted into an application using an application initialization mechanism in one embodiment. For example, Windows provides an “AppInit DLLs” mechanism that operates as a key in the registry. The “AppInit DLLs” lists the DLLs that are injected into processes on the system. The AppInitDLLs loads the DLLs listed in a registry key whenever a DLL “user32.dll” is loaded into process memory. Other techniques for inserting an agent as a shared library may be used, including techniques in UNIX, LINUX, OSX, or other operating environments.

In another example, security agents 162-166 are forcibly injected into applications 132-136 using a debugging application programming interface. In another example, Kernel techniques such as APC Queuing, or manipulation of the same, are used to cause particular processes to load the security agent as a shared library. The security agents may be forcibly injected into applications using a security engine 152 in a WINDOWS, LINUX, or OSX kernel. In various implementations, the described security system may include components in one or more of the kernel and application layers. Applications 162-166 may include, but are not limited to, software processes, including threads, executables, libraries, etc. In various examples, security agents 162-166 may be injected into one or more instructions, processes, threads, executables, or libraries, for example.

Security agents 162, 164, and 166 monitor applications 132-136 for various events and in response call an security verification function. Agents 162-166 may generate event notifications which are transmitted to security engine 152 and/or security kernel 172. In another example, agents 162-166 may execute all or a portion of the security verification function. Security engine 152 and/or security kernel 172 may independently detect events, or may receive event notifications to detect events with applications 132-136. In response to an event, the security system performs the security verification function including one or more of a thread verification, code verification, stack verification, and/or execution path verification.

The security system includes an analysis engine as part of security engine 152 in one embodiment. The analysis engine is configured to generate or receive a predefined list of execution paths associated with the application. The predefined execution paths list known or legitimate execution paths within the application. During execution of an application, the execution path of the application is compared with the list of predefined execution paths. If the execution path does not match a predefined execution path, the system can generate a security event to block execution code or indicate the anomaly.

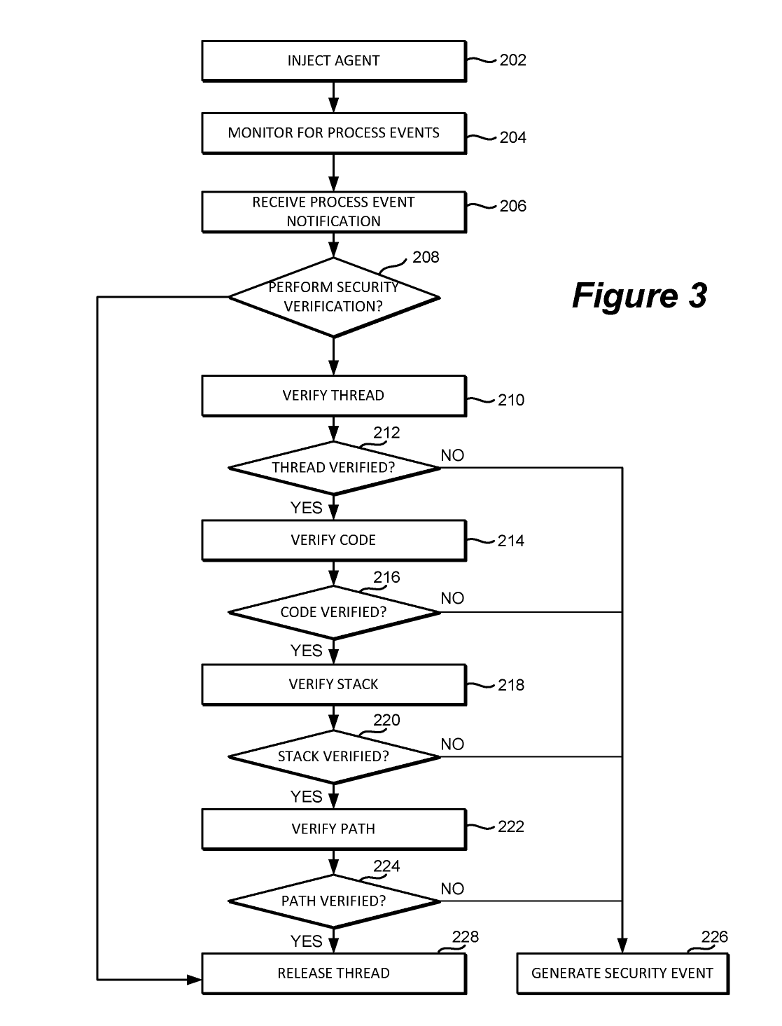

FIG. 3 is a flowchart describing a process of providing system security for a subset of code that can be performed to verify code prior to execution in accordance with one embodiment. At step 202, a security agent is injected into a process such as an application, shared library, executable, or any other software module. A security agent such as agents 162-166 can be injected by a security engine 152 in one example. The security agent can be injected by a security user component of security engine 152 using an AppInitDLLs technique in one embodiment. A DLL or other library/executable may be inserted into the application by listing the shared agent in a registry key that is loaded when a shared library such as “user32.dll” is loaded by the process into memory for the process that is being monitored. In one embodiment, a debugging API is used to forcibly inject the security agents into the application. In another example, a security kernel component of security engine 152 may be used to forcibly inject the security agents by APC queuing or manipulation of the process so that it loads the library.

At step 204, the security agent monitors the process to detect various events associated with the process. For example, the security agent may be configured to receive DLL events associated with the process such as thread attach/detach events. The agent may monitor for a “DLL_THREAD_ATTACH” event in one embodiment. A “DLL_THREAD_ATTACH” event may be triggered before a thread begins execution of code when a thread is created. The event can occur on the same thread which is being created. The injected security agent has the ability to read memory of the process, thread, etc. as if it was the thread's executive code. In one embodiment, the security agent receives a message or notification every time a module is loaded with the same address space. In one example of a kernel implementation, the function PsSetCreateThreadNotifyRoutine can be used to catch these new threads being created in kernel land.

In response to a process event associated with the application or process being monitored, the security agent generates a process event notification which is received by the security engine at step 206. The process event notification identifies the process event and may optionally include a rating associated with the process event. The process event notification may also include an application programming interface call or any other notification or indication in either user or kernel land to trigger security verification by the security system. In one embodiment, event notifications can be generated by code inserted into the process at any point. The process code may be modified randomly to insert code generating random event notifications to trigger verification. An event notification may be generated in response to any system call by the operating system, any time various functions in libraries (e.g., Win32 API functions) are being used, or through various events by the operating system in user land or kernel land. In one example, the activation or generation of an event notification is arbitrary. In one embodiment, the security system may perform checks remotely on another process or application through direct memory access, or through a debugging API (e.g., OpenProcess, ReadProcessMemory, Ptrace on Unix).

In one implementation, several functions are hooked using modification of source and/or object code. Functions often used with exploits may be hooked. General purpose functions may be called more often. For example some APIs that may be hooked include CreateFile, CreateFileMapping, ShellExecute, CreateProcess, OpenFile, SetProcessDEPPolicy, VirtualProtect, NtSetProcessInfo, URLDownload, LoadLibrary, WinExec, WriteFile, ReadFile, connect, recv, send, and GetProcAddress as may be used in Windows. The aforementioned APIs are an example of a set of functions that may be used to active the security verification to mitigate invisible threads, ROP, packing, and other malicious exploitation techniques.

At step 208, the system determines whether to perform security verification in response to the event. Step 208 is optional as all event notifications may result in security verification in one embodiment. Events or event notifications can be rated in one implementation. For example, the system may use a rating of 1-10 although any rating technique may be used. Event notifications relating to system calls, for example, that are often used with malicious activity such as CreateFile may receive a high rating (e.g., 10) indicating a more probable use of malicious activity while other event notifications may receive a lower rating (e.g., 1) to indicate less likelihood of use of malicious activity. In response to event notifications with a higher rating, the security system may perform more security verifications or may perform security verification more often. In response to lower rated event notifications, the security system may perform fewer security verifications. A threshold rating may be set where the system only performs security verification if the event notification has a rating above the threshold. Additional thresholds may be used to determine whether all security verifications should be performed or whether only a subset of the verifications should be performed. For example, a single path through the thread, code, stack, and path verifications is shown in FIG. 3. In one embodiment, however, the security system may perform a single one of these verifications or any combination of these security verifications based on the event rating.

If no security verification is to be performed, the method of FIG. 3 proceeds to step 228 where the associated thread is released for execution by the CPU. If security verification is to be performed, the method proceeds to step 710 where one or more threads associated with the event notification are verified. The security engine verifies the thread in one embodiment by determining whether the thread matches at least one legitimately loaded module associated with the operating system. The security engine may determine if a thread start address matches an address of a module such as a library loaded during process initialization, or an address of a normal operating system routine. The security system may also verify whether the library is inside a list of particular or legitimate operating system or application libraries. In one embodiment, the system can pass the library to another function to check whether the library is legitimate regardless of it being a real file on the computer system. The checking mechanism may include anti-virus signature verification, heuristical verification to determine if the library call functions and methods appear like a backdoor, and/or a log of when the library was first introduced to the computer system. The library checking function can be implemented by hooking various library loading routines such as “LoadLibrary,” “dlopen,” etc. If the thread is not verified as determined at step 212, a security event can be generated at step 226.

At step 214, the security system verifies code associated with the event notification. The security system can verify one or more code segments for one or more threads associated with the event notification. The security engine verifies the code of the thread based on a comparison with code from the storage system or other trusted source in one embodiment. The system can load a second copy of the thread's code from storage into memory using a different base address. An example under WINDOWS would be to open the application or libraries file and load into memory under a different base address. Relocation changes are applied to the second copy of the thread code using the base address of the original copy of the thread code. The two copies of code are then compared to detect any differences. In WINDOWS, this will ensure that the integrity of the current (real OS/shared library mechanism) and the new location in memory (for verification) matches. If the code fails to match between the two copies, the code verification fails. If the code verification fails as determined at step 716, a security event can be generated at step 226.

At step 218, the security system verifies the stack in response to the event notification. In one embodiment, the security system verifies the legitimacy of one or more ranges of the stack associated with the event notification. For example, the security system verifies that the thread's start address is located on the sack in one embodiment. In this manner, if an exploit has changed the stack address to point to a gadget related to the exploit, the thread start address will not be visible on the thread. In another embodiment, the security system alternately or additionally verifies that the stack is within the original heap address range. The security system may also verify that the functions in the stack are each viable executable code. The system can walk the stack backwards finding each parent calling function of the current function until the thread start is reached. The security system verifies that the entire stack is valid. The system can also verify that the code calling each child function matches the original code from the storage system such as disk. If the stack fails any of the verifications as determined at step 220, a security event can be generated at step 226.

At step 222, the security system verifies one or more paths associated with the event notification. The security system can verify that a code path of one or more threads associated with the event notification match a predefined execution path in one example. The security engine may analyze each application or library that is loaded for various factors in order to train the security engine or otherwise develop an outline of each application being monitored. For example, the security engine may create a list of each calling function (e.g., assembly language operation call), conditional or absolute jump, jump tables and their destination (e.g., jne, ja, etc.) and all possible branches due to comparing operations with a variety of possible conditional jumps in assembly code (e.g., cmp, eax, 1, je). The analysis engine can create an outline of the application, including all possible code, the specific order, etc. in order to determine all possible code paths that may be taken when the code executes. The security engine can compare an execution path associated with the thread with these analyzed execution paths. If the thread's execution path does not match any of the predefined execution paths determined from the analysis, the path verification fails at step 224 and a security event can be generated at step 226.

If the security engine verifies the thread, code, stack, and path in response to the event notification, the thread is released for execution at step 228. Although the verification functions in FIG. 3 are performed in response to an event notification generated by a process event, other techniques may be used to trigger security verification. For example, an event notification may include any call to a security verification function. Any number of event notifications including APIs which may be differ by operating system in user land or kernel land may be used.

Although the verifications in FIG. 3 are predominantly described as being performed by security engine 152, the verification functions may be executed in various manners. In one embodiment, the verification functions are performed exclusively by the security agents. The security agent may receive an event notification and perform one or more of the verification functions 210, 214, 218, and 222 to determine whether to block or release a thread.

Moreover, individual verifications at steps 210, 214, 218, and 222 may be called independently of one another. For example, the security system may receive an event notification and perform a thread verification at step 210 only to determine whether to release or block a thread. By way of further example, an event notification may be received that trigger a code verification, stack verification, or execution path verification. Moreover, an event notification may be received that triggers any combination of these verifications to determine whether to release a thread or generate a security event. Event notifications can be rated as described herein to determine if any verification functions are triggered and if so, which ones.

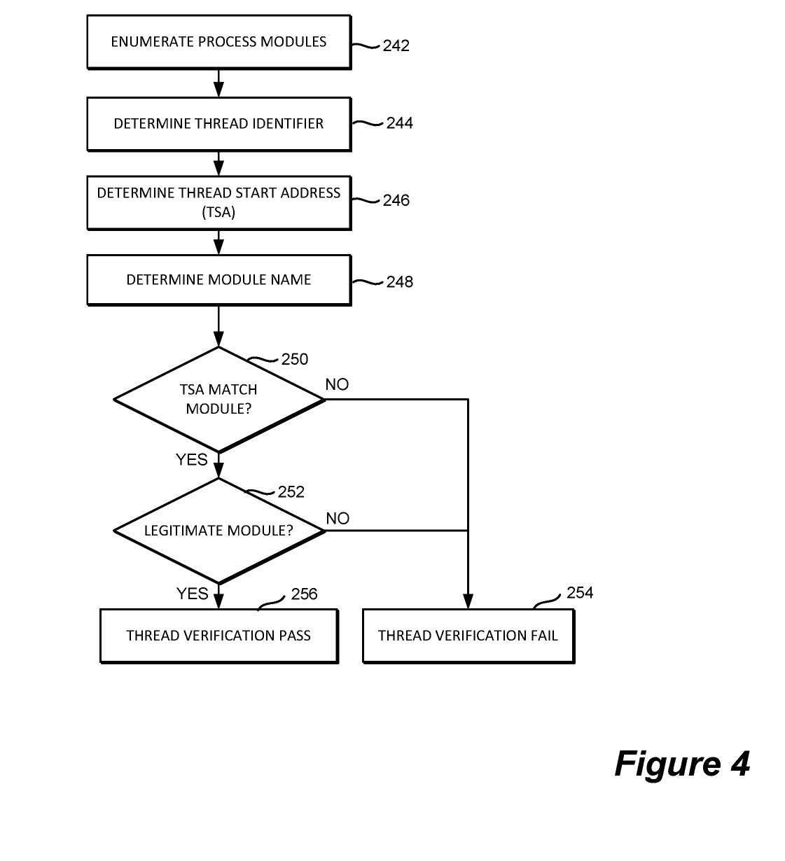

FIG. 4 is a flowchart describing a process of thread verification in accordance with one embodiment. In one embodiment, the process of FIG. 4 may be performed at step 210 of FIG. 3. In another embodiment, the thread verification process of FIG. 4 may be performed independently of the process in FIG. 3 and the other verification functions described herein. For example, thread verification may be performed in response to an event notification to determine whether to execute or block a thread from execution.

At step 242, the security system enumerates shared process modules associated with the event notification. In one example, the security system enumerates the shared libraries associated with the process being monitored or of the operating system. The security system may enumerate all shared libraries or a subset of the shared libraries in one embodiment. The security system may list the loaded libraries in one example, including user-land executables, DLLs, “.so” libraries for UNIX based operating systems, “dylib” files for OSX operating systems. The security system may alternately or additionally enumerate kernel land system drivers in implementations that include a security kernel component, for example, in the WINDOWS, LINUX, or OSX kernel. In one example, the list of shared libraries includes a list of all modules (e.g., drivers, DLLs, executables, libraries), including the base address allocated to the module and the highest address allocated to the module.

At step 244, the security system determines a thread identifier or other indication of the thread associated with the event notification. At step 246, the security system determines a thread start address for the thread identifier. In one embodiment, the security system may query the operating system for the thread start address. The system may query the WINDOWS operating system using an NTQueryInformationThread API. The system may query the function NTQueryInformationThread using the ThreadQuerySetWin32StartAddress parameter to obtain the address on which the thread execution for the thread identifier will begin. In another example, the query may obtain the address of the current thread to be executed.

At step 248, the security system determines the module name corresponding to the thread start address, indicating which module the current thread is within. The security system can determine which enumerated module has an address range corresponding to the thread start address in one embodiment.

At step 250, the security system determines if the thread start address matches a legitimate module associated with the operating system. The security system can determine if the thread start address matches any of the enumerated modules in one embodiment. The system may determine whether the operating system returns a module name corresponding to the thread start address or whether the thread start address is within any of the ranges of the enumerated modules from step 242. If the thread start address does not match any of the enumerated modules, the thread verification process fails at step 254

At step 252, the security system verifies whether the module corresponding to the event notification is legitimate. The system may determine if a module such as a library is in a set of particular operating system or application libraries. The security system can verify that the library associated with the thread is legitimate, independently of whether it is enumerated or otherwise corresponds to a real file on the computer system. In one embodiment, the system passes the module to a verification function to determine whether the module is legitimate. This checking function can apply anti-virus or other signature verification to heuristically verify and determine if the library call functions and methods similar to a backdoor. The checking function may also verify the date and log of when the module was first introduced to the computer system. The checking function can be executed by hooking various library loading routines such as “LoadLibrary,” “dlopen,” etc. If the module is not verified at step 252, the thread verification fails at step 254. In one embodiment, a security event can be generated in response to failing thread verification. The security event may block the thread from execution and/or generate an alert such as a notification to an administrator. The alert may include a visual or audible alert associated with the computer system or another computer system, a message generated and sent to the administrator, etc. If the module is verified at step 252, the thread verification passes at step 256.

It is noted that some legitimate applications may use self-modifying code. These applications may be white listed if desired, or training may be used where it is passive to build a rule set of what is seen whenever the security engine is installed on a new machine or a new application is installed.

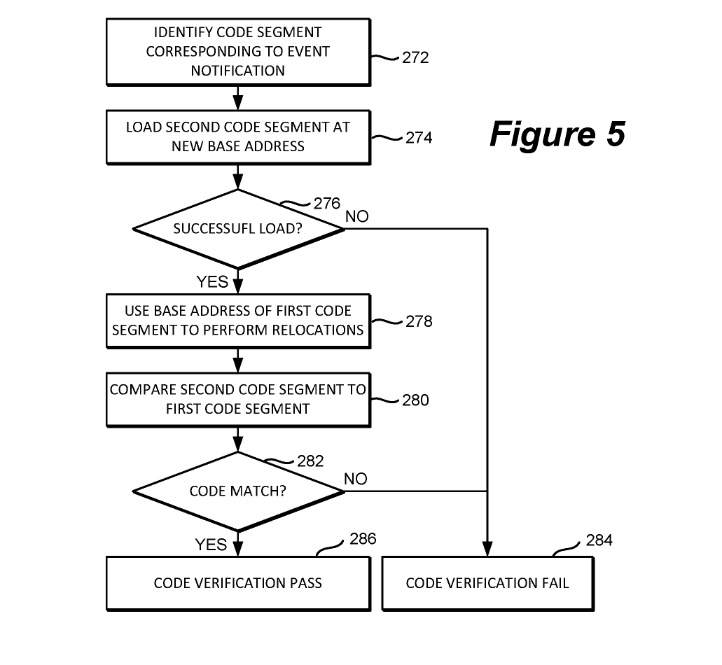

FIG. 5 is a flowchart describing a process of code verification in accordance with one embodiment. The process of FIG. 5 may be performed to verify the legitimacy of any code section associated with an event notification. For example, the security system may compare the copy of a thread's code loaded in memory for a process with a second copy loaded from storage by the security system to determine whether the current copy executed in memory matches the second copy from storage. In this manner, the security system can detect if the original copy has been modified from its original form in storage. In one embodiment, the process of FIG. 5 may be performed at step 214 of FIG. 3. In another embodiment, the code verification process of FIG. 5 may be performed independently of the process in FIG. 3 and the other verification functions described herein. For example, code verification may be performed in response to an event notification to determine whether to execute or block a thread from execution.

At step 272, the security system identifies one or more code segments corresponding to the event notification. The security system identifies one or more sets of code for the thread associated with the event notification in one embodiment. The security system may identify code stored on storage system 106 in the hardware layer 100 for example. In one example, the security system determines a filename for the software module corresponding to the thread at step 272. The security system may determine the module name as shown in FIG. 4, and then identify a corresponding filename on storage system 106.

At step 274, the security system loads one or more second code segments corresponding to the one or more first code segments. A second copy of the one or more code segments for the thread are loaded using a second base address in one embodiment. At step 276, the security system determines if the code was successfully loaded. If the security system cannot load a second copy of the code, the code verification process fails at step 284. In one embodiment, a security event is generated in response to a code verification failure. If the system loads the second copy of the code, the code is modified at step 278 based on a first base address associated with the original copy of the code in memory 104. The security system loads the second copy and applies relocations using the original base address. In this manner, the second copy of the thread's code will match the original copy of the code, if the original copy has not been altered. The relocations will cause the second copy to match byte for byte with the original copy.

At step 280, the security system compares the second copy of the thread's code in memory with the original copy of the thread's code in memory. The comparison ensures integrity between the original copy of the thread's code (real operating system/shared library mechanism) and the second copy just loaded from storage. A binary comparison or checksum (e.g., MD5/SHA256) can be performed on the data of the two copies of the thread's code.

At step 282, the security system determines if the original copy of the code matches the second copy of the code loaded into memory. If the data is equal, it indicates that the original copy has not been maliciously modified since the libraries were originally loaded into memory. If the data is not equal, it indicates that the original copy has been maliciously modified outside of the normal operating system processes. The alterations to the code could be the result of a packer, or because of other reasons such as backdoors, injected code, etc. If the code matches, the code verification passes at step 286. If the code does not match, the code verification fails at step 284.

It is noted that some legitimate applications may use packing techniques. These particular applications can be white listed on a case-by-case basis, trained, or profiled by an administrator in one embodiment.

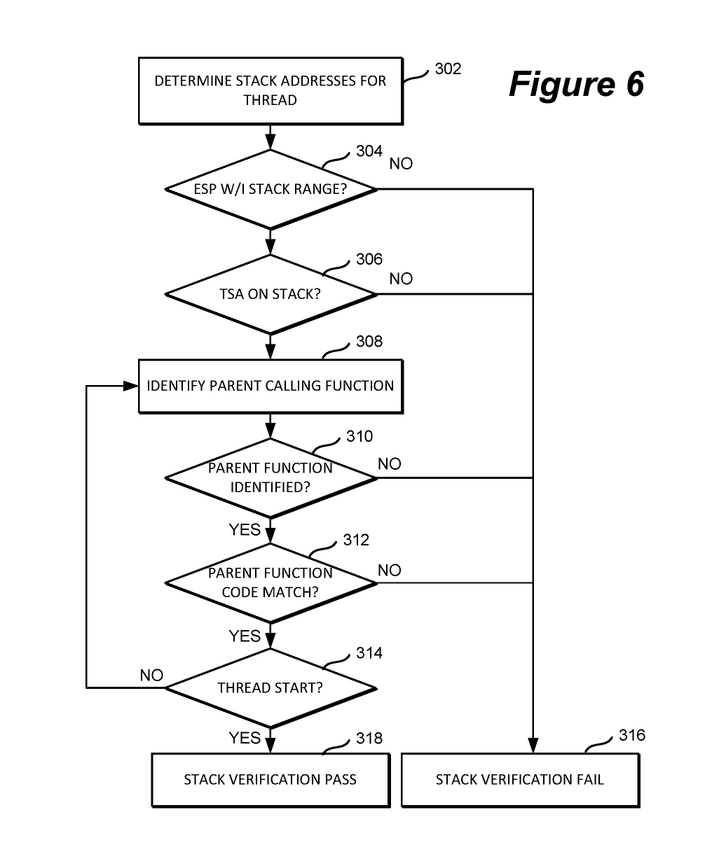

FIG. 6 is a flowchart describing a process of stack verification in accordance with one embodiment. The security system verifies that the stack has not been altered in a manner indicating a malicious modification of code in memory. In one embodiment, the process of FIG. 6 may be performed at step 218 of FIG. 3. In another embodiment, the stack verification process of FIG. 6 may be performed independently of the process in FIG. 3 and the other verification functions described herein. For example, stack verification may be performed independently in response to an event notification to determine whether to execute or block a thread from execution. A process or application can be modified in one embodiment to randomly insert stack verification anywhere. Stack verification may occur any time the operating system initiates a system call, any time various functions in libraries are being used (e.g., Win32 API functions), or through various events by the OS in user land, or kernel land. In one example, activation may be arbitrary or happen as often as possible or during important events. In one embodiment, stack verification may remotely perform checks on another process through direct memory accessing, or debugging API (OpenProcess, ReadProcessMemory, ptrace on Unix based operation systems). One example may hook several functions that are used with exploits, and some that are general purpose. These may be rated as earlier described to determine when to initiate stack verification. Some of the APIs that may be hooked include: CreateFile, CreateFileMapping, ShellExecute, CreateProcess, OpenFile, SetProcessDEPPolicy, VirtualProtect, NtSetProcessInfo, URLDownload, LoadLibrary, WinExec, WriteFile, ReadFile, connect, recv, send, and GetProcAddress. The aforementioned API's are presented as example functions only as others or fewer than those listed may be used. The hooked API's may be used to activate a security check which will mitigate ROP, and other exploitation techniques.

At step 302, the security system determines one or more stack addresses associated with a thread for the event notification. In one embodiment, the security system determines the base address and the highest address allocated for the thread on the stack. At step 304, the security system optionally determines if the stack pointer (e.g., ESP) is currently within the stack range. If the stack pointer is not within the stack range, the stack verification fails. If the stack pointer is within the stack range, the process continues at step 306. In one embodiment, step 304 is not performed. At step 306, the security system determines if the thread start address for the current thread is located on the stack. If the thread start address is not on the stack, the stack verification fails at step 316. If the thread start address is not on the stack, a return-object programming (ROP) exploit may have changed the stack address to point to a gadget for an exploit such that the thread start address is no longer visible on the thread. Such instances indicate that the thread may have been manipulated by a malicious piece of code.

At step 308, the security system begins another verification to ensure that all functions in the stack are viable executable code. The security system identifies the parent calling function of the current thread at step 308. At step 310, the security system determines if the parent function was identified. For example, the security system may determine if the parent function is on the stack. If the security system is not able to identify the parent calling function, the stack verification fails at step 316. If the security system is able to identify the parent calling function, it determines whether the current copy of the parent function in memory matches a second copy of the parent function loaded from storage. The security system verifies that the area of code for the parent function is the same as it is in storage. The process in FIG. 6 may be used to load and apply relocations for the parent calling function. If the parent function copy loaded from storage does not match the original copy in memory, the stack verification fails at step 316.

At step 314, the security system determines whether the current parent function is at the thread start. If not, the security system returns to step 308 to identify the parent calling function of the current function. If the thread start has been reached, the stack verification passes at step 318.

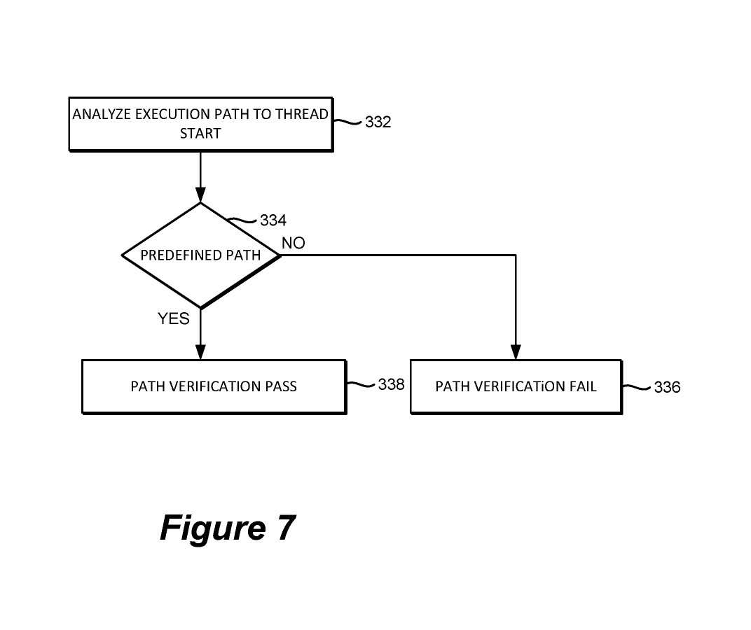

FIG. 7 is a flowchart describing a process of path verification in accordance with one embodiment. The security system verifies that the current code path matches one or more predefined or whitelisted code paths to ensure that only known code paths are executed within the computer system. In one embodiment, the process of FIG. 7 may be performed at step 222 of FIG. 3. In another embodiment, the path verification process of FIG. 7 may be performed independently of the process in FIG. 3 and the other verification functions described herein. For example, path verification may be performed independently in response to an event notification to determine whether to execute or block a thread from execution. The security system analyzes one or more applications in one embodiment to develop a list of predefined execution paths for a process such as application 132. In one embodiment, the security system analyzes each application during a training phase to log or otherwise develop a list of authorized execution paths.

At step 332, the security system responds to an event notification by analyzing to determine an execution path associated with the event. The security system may determine the parent calling function for each function beginning with a current function, such as the thread initiating the event notification. After identifying the parent calling function, the security system identifies the senior parent calling function, etc. The code path of the senior parent calling function is then analyzed. This process is repeated until the thread start is reached. The security system compares the identified execution path with the predefined execution paths to determine if the execution path is legitimate at step 334. If the identified execution path does not match one or more predefined execution paths, the path verification fails at step 336. If the security system determines that the identified execution path matches at least one predefined path, the path verification passes at step 338.

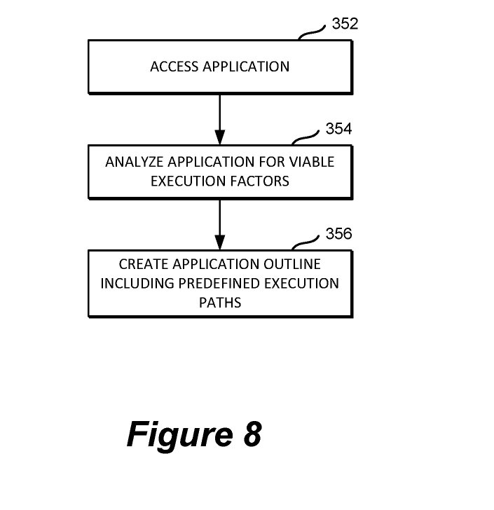

FIG. 8 is a flowchart describing a process of analyzing an application to generate a list of predefined or legitimate execution paths used by the security system to identify malicious modifications of code. In one embodiment, the process of FIG. 8 can be used to generate a list of predefined and/or whitelisted execution paths used in the process of FIG. 7. At step 352, the security system accesses the application to be analyzed. At step 354, the security system analyzes the application for viable execution factors. In one embodiment, the security system creates a list of each function call for the application, a list of each jump in the application, a list of the jump tables and destinations in the application, and a list of possible branches within the application based on a comparison of operations with possible conditional jumps in assembly code (e.g., cmp_eax, 1, je blah). The jump table destinations may include “jne,” “ja,” etc.

At step 356, the security system creates an outline of the application. In one embodiment, the outline identifies all possible code and code paths within the application. The outline can identify specific orders of code execution. The outline can identify all possible code paths that the code executes for the application, to determine all possible code paths that may be taken while the code executes. In this manner, the system can compare identified execution paths in response to an event notification to a list of predefined execution paths in the outline to determine if the code path is legitimate before allowing the central processing unit to execute the code instructions from memory.

It is noted that logic errors may not be detected, such as when the application compares incorrectly in assembly code, and thus is using real code inside of the application itself to perform all actions. These can however be defeated using while listing of these code paths by training the engine using real execution of the applications and only allowing prior code paths that were seen before. This can block any particular logic bugs that are unknown. It is noted that PHP programs may have different code paths because during execution and the order it calls specific functions while it is interpreting the PHP script these paths would be different. This system may happen at the hypervisor level, kernel level, user land, or hardware.

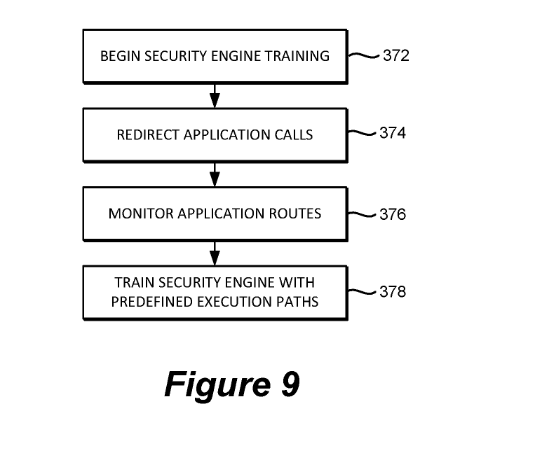

FIG. 9 is a flowchart describing a process of analyzing an application to generate a list of predefined execution paths in accordance with one embodiment. In one embodiment, the process of FIG. 9 can be performed at step 354 of FIG. 8. At step 372, the security system begins security engine training. In one example, step 372 includes setting the security system to a training mode to locate code paths and execution patterns. At step 374, the security system redirects application calls within each monitored application to the security system. In one example, the application calls are redirected to trampolines. At step 376, the routes or execution paths within the application are monitored. Each possible execution pattern with the application can be monitored. At step 378, the security engine is trained with predefined execution paths for the application. The security engine generates a list of predefined execution paths which are later compared with identified execution paths of code in memory.

In one embodiment, a monitoring module redirects every call in an application to trampolines that can be used to verify, and monitor the application's routes as if it were traffic with vehicles. The module monitors the application routes over time and trains the security system. By monitoring the application routes the security system can be trained. During a security check (e.g., as activated by a hooked API as earlier described), the security system can ensure that the application is following a path that has been seen before, trained, etc.

If every call is redirected to a particular table, then specific areas can be activated or deactivated, such as those deemed unnecessary, or possibly called too often and that may slow down the application. This would allow the security system to self-learn and optimize its own speed when dealing with CPU, or data intensive applications.

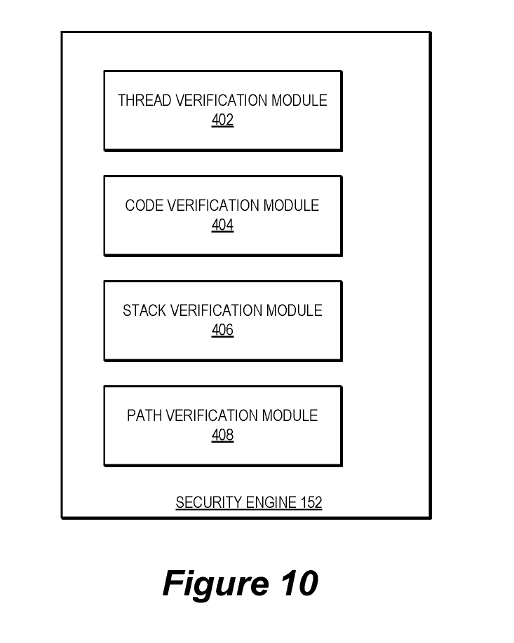

FIG. 10 is a block diagram of a security engine 152 in accordance with one embodiment. Security engine 152 may include components in the application layer and/or the kernel layer. Moreover, although shown as part of security engine 152, any one or a combination of the components depicted in FIG. 10 may be implemented as security agents in one embodiment. In FIG. 10, security engine 152 includes a thread verification module 902, a code verification module 904, a stack verification module 906, and a path verification module 908. Although shown as software modules in FIG. 10, the various modules may be implemented in hardware in alternate implementations or as combination of hardware and software. According, thread verification module 402 may include a thread verification circuit in one embodiment. Code verification module 404 may include a code verification circuit in one embodiment. Stack verification module 406 may include a stack verification circuit. Path verification module 408 may include a path verification circuit.

Thread verification module 402 is configured to identify a plurality of software modules in a computer system in response to a process event. The thread verification module determines a thread start address for a first thread corresponding to the event notification, determines whether the first thread is associated with one or more software modules of the plurality based on the thread start address, and generates a security event if the first thread is not associated with the one or more software modules.

Code verification module 404 is configured to respond to a process event by determining in a memory a first base address of a first code segment. The code verification module loads in the first memory at a second base address a second code segment corresponding to the first code segment. The code verification module modifies the second code segment based on the first base address and compares the second code segment to the first code segment after modifying the second code segment. The code verification module generates a security event if the first code segment does not match the second code segment.

Stack verification module 406 is configured to respond to a process event by determining one or more stack addresses allocated for the first thread by an operating system, determining whether the thread start address is within the one or more stack addresses allocated for the first thread, and generating a security event if the thread start address is not within the one or more stack addresses allocated for the first thread.

Path verification module 408 is configured to response to an event notification associated with a first thread, determining a thread start address for the first thread, determining a first execution path of the first thread based on the thread start address, comparing the first execution path with a plurality of predefined execution paths for an application associated with the first thread, and generating a security event if the first execution path does not match at least one of the predefined execution paths for the application.

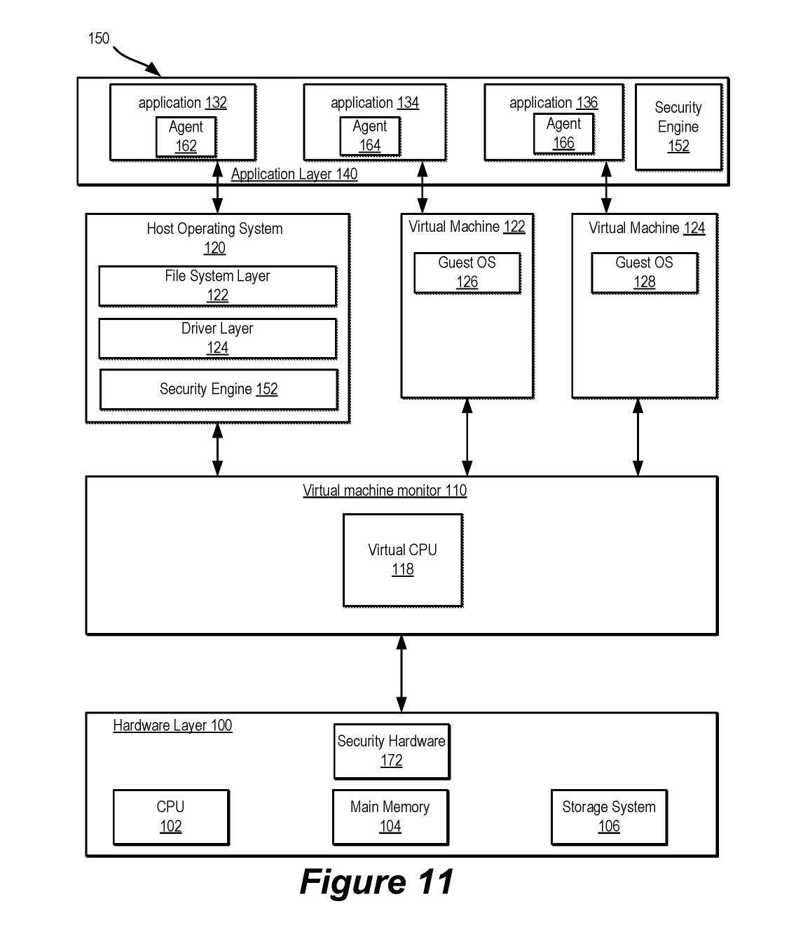

FIG. 11 depicts another example of a computer system 150 in accordance with an embodiment of the disclosed technology. In FIG. 11, security hardware 172 is provided in hardware layer 100 to provide security at the hardware level. Security hardware 172 can include one or more circuits in communication with the CPU 102 and main memory 104 over one or more buses (not shown). The security hardware may sit in front of the CPU and/or main memory 104 to verify that code paths and other perform other security mechanisms. The security hardware is provided to implement the described security functions on a hardware basis for embedded systems in one example. Security hardware 172 may use software to deliver basic information about software modules, and their memory addresses (whether physical or RAM), etc. Checks can then be performed on application instructions before the instructions reach the CPU. In one embodiment, security hardware 172 is a custom RAM module. The RAM module may be configured not to allow particular code to be executed by the CPU if it does not fall within a predefined execution path. The RAM module may block the CPU from retrieving the identified instructions.

Thus, one embodiment includes a central processing unit, a memory coupled to the central processing unit, and a security circuit coupled to the memory and the central processing unit. The memory is configured to store a plurality of processes for execution by the central processing unit. The security circuit is configured to access a plurality of instructions associated with a first process and compare an execution path associated with the plurality of instructions with a plurality of predefined executions paths for the first process. The security circuit is configured to block execution of the plurality of instructions in response to the execution path not matching at least one of the predefined execution paths.

In one embodiment, a custom operating system is provided to remove address space randomization layers. Because all paths are verified using a code matching firewall, determining memory addresses will not provide an attacker with an opportunity to institute an exploit. This may enable a decrease in system complexity and allow a security system to be implemented in hardware without using operating system notifications of codes/modules, and their current addresses for verification of paths.

In one embodiment, a hypervisor (in virtualization layer 110, e.g.,) implementation is provided. The security engine in the hypervisor may access system calls (syscalls) for the operating system to communication and updates lists of paths such as predefined execution paths, address of modules, etc. In this manner, the security engine can activate verification checks as often or as infrequently as desired, and/or based on a particular activation such as an event notification. For example, event notifications relating to particular OS functions being called by their addresses, or when the operating system itself triggers through communication, can be used. In another example, the verification checks may be triggered randomly by time or at every instruction.

In one embodiment, the security engine 152 is implemented exclusively in the application layer 140 (e.g., in user-land). The security engine may attach a debugger to each process on the system and place hooks to generate event notifications to trigger security checks. Agents 162, 164, and 166 may include these hooks. The hooks are placed at system calls, library calls, etc. in one embodiment. The hooks may trigger verification that a code path is legitimate in one example. In another embodiment, verification is performed using single step debugging on an application to verify that every instruction and piece of code is legitimate.

In one embodiment, various methods for caching information and determining if memory has been changed, etc. are provided in order to optimize performance of the security system. The security engine may access OS notifications on permissions changing on pages of memory to determine if a particular region of memory should be rechecked. In one example, the security engine manipulates the PAGE_GUARD instruction to determine whenever particular areas of memory are accessed. This may include a threads stack to determine if functions return on a particular thread so that the security engine is not required to re-check the same stack functions for the same thread. One embodiment includes providing a rating for event notifications to determine which are potentially more hostile, such as those used on a wider scale by exploits. By way of example, the thread event URLDownloadToFile in Windows may be rated higher to indicate a greater probability of association with an exploit. When the event notification is rated high, the security engine may verify the entire stack, or the entire code path associated with a thread in response to the event notification.

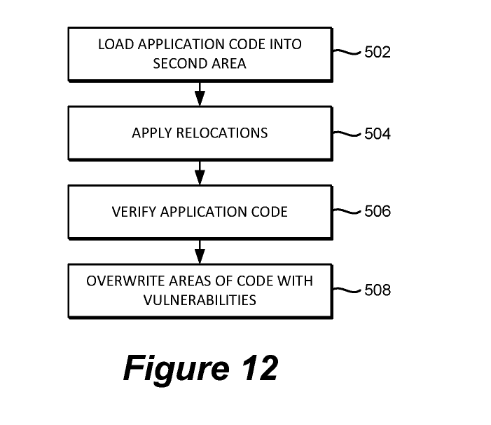

In one embodiment, a mechanism is performed when a security engine or module is first inserted into an application. FIG. 12 is a flowchart describing a process of exploit mitigation in one embodiment. The security engine can load the application's code from disk into a second area at step 502. At step 504, the security module applies relocations. At step 506, the security module verifies the application code. If the application has hooks that may be from things such as viruses, other anti-virus applications, etc., the security module can over-write these areas of code with the original from disk at step 508. The software's own modifications to the application to redirect, or implement its security mechanisms can be allowed.

In one embodiment, heap vulnerabilities can be mitigated by hooking HeapAlloc, HeapCreate, and the other functions within this area of memory management features. The heap can have randomized amounts of padding that are appended behind each memory allocation. This can be performed by manipulating HeapCreate( ) for heaps other than the processes global heap, and may by performed by faking sizes by HeapQueryInfo. This means that exploits aren't actually exploiting anything, and with the randomization then it would make it very difficult depending on a case by case basis whether a bug can be triggered.

The analysis engine may statically, or heuristically detect custom heap engines to perform the same techniques on applications that use them. Internet Explorer, Firefox, Adobe, etc all have versions that use custom heaps which would not trigger by hooking HeapAlloc( ), malloc, brk( ) (unix), or other memory allocation functions.

Techniques for automatic vulnerability patching of applications, programs, and various types of processes are provided in one embodiment. Processes for modification of the assembly-level or other low-level language of an application are provided. In one example, the assembly or other low-level language of applications can be modified after execution (e.g., on the fly), or before the execution gets passes to the entry point on initialization of execution. For example, the assembly code of an application can be modified in memory using hooks. In another example, the assembly code of an application can be modified by realigning. One or more portions of an application can be rewritten with new memory addresses for the relative jumps, etc. By way of example, instructions such as “call,” “jmp,” “jz,” “jnz,” “jbe,” “jle,” “jge,” “ja,” “jb,” “js,” “jl,” “jg,” “jnp,” “jo,” “jns,” “jp,” “jecxz,” and “push” can be rewritten. If an application's assembly code is modified, then these assembly instructions can be modified to adjust for code being in different places.

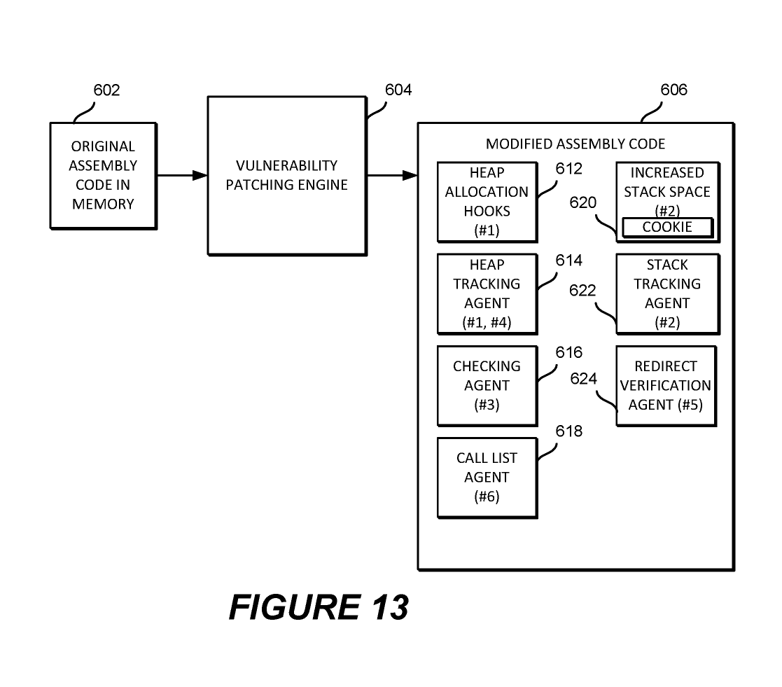

FIG. 13 is a block diagram describing a process of assembly code modification for automatic vulnerability patching in accordance with one embodiment. The original assembly code 602 of a process or application is provided in a memory such as memory 82 including a RAM or ROM. The original assembly code may be loaded into memory 82 from mass storage 84 or elsewhere for execution by processor 80. A vulnerability patching engine 604 is stored in mass storage 84 or is otherwise accessible to memory 82 where it is loaded and executed by processor 80.

The patching engine monitors a load library associated with an operating system, for example, and determines when an application or other process is executed. The patching engine accesses the original assembly code 602 for the application and generates modified assembly code 606. The modified assembly code includes one or more of heap allocation hooks 612, heap tracking agent 614, checking agent 616, call list verification agent 618, increased stack space 620, stack verification agent 622, and call redirect verification agent 624. The increased stack space 620 is shown as part of the assembly code 606 but may include memory allocated by an operating system for the application or process and modified by the patching engine 604.

Techniques of assembly code modification are provided for heap memory and/or stack memory protection in one embodiment. Techniques are provided for padding memory allocations by an application on a heap using heap allocation hooks 612 in one example. Hooks are inserted into functions within the original assembly code of an application or process that relate to dynamically allocated heap memory in one embodiment. Techniques are also provided for padding each memory allocation by an application on the stack to generate an increased stack space 620. In one example, disassembly of assembly instructions is used to modify applications to pad stack memory allocations. The heap tracking agent tracks heap allocations and analyze the heap for potential exploits relating to the corresponding application or process. The stack tracking agent tracks memory allocations on the stack for potential exploits relating to the corresponding application or process. The checking agent is added to assembly code to monitor and check for potential exploits relating to overwrites of memory. The redirect verification agent redirects individual calls and verifies the calls during execution to detect potential exploits. The call list agent utilizes a list or array of the call structure of an application to ensure that calling functions and paths match those on initial load of the application.

In one embodiment, a process for heap and/or stack protection is provided by padding memory allocations on the heap and/or stack. Heap allocation sizes are increased to provide padding as well as to produce unexpected memory sizes so that an attempted attack through an exploit, for example, will fail by hooking a heap allocation function. The stack size can additionally or alternatively be increased by modifying an application's assembly code to increase the stack size of functions that have static (stack) memory to provide unpredictable memory sizes to break or otherwise mitigate exploits. In one embodiment, the heap management functions are hooked such that a full modification of code is not performed.

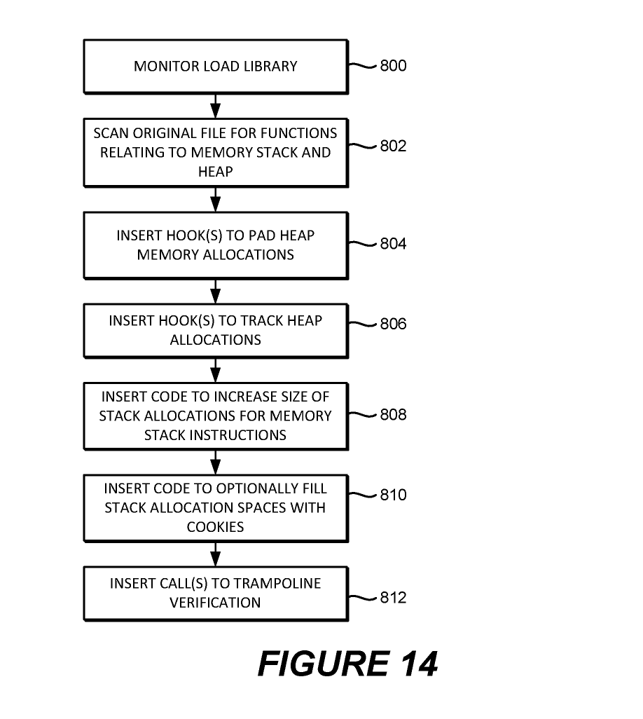

FIG. 14 is a flowchart describing a process of modifying assembly code in accordance with one embodiment. In FIG. 14 heap and stack protection is provided by padding memory allocations within the system. At step 800, a load library is monitored. In one example, a debugger is used to connect to each application that is loaded. In another example, applications are executed under the control of an agent. For example, applications can be modified or instrumented to include the agent.

In one example, a patching agent is implemented or installed on each client device enabling code monitoring modification as described herein. For example, the patching agent may monitor the load library at step 800. When an application or process is loaded, the patching agent can modify the application as described. The patching agent may rewrite functions within the application to new memory locations and/or modifying the original application with jumps or calls to new memory locations for example. In one example, applications are modified or instrumented to include the patching agent.

When an application is loaded, the patching agent scans the application for individual functions at step 802. In FIG. 14 the patching agent attempts to identify all functions within the application that relate to memory stack and memory heap allocations. For example, the agent can identify specific functions that relate to dynamically allocated heap memory or to stack allocations.

At step 804 the agent inserts one or more hooks into each function to pad the heap memory allocations for the function. For example, the hooks may be used to insert a pad before the buffer and then also add a pad behind the buffer. The pad can be a random size in one example. For example a page size of one page to four pages or another arbitrary number of pages can be used in one example. The hook can be inserted into the application in one example to call a function for inserting the pad in one embodiment. By padding the heap, any exploits prepared with the original addresses will be broken or otherwise rendered inoperable. Moreover, such a technique is capable of blocking exploits that have yet to be discovered. By padding the heap memory allocations, the amount of space is increased for each function in memory. The increase in space is automatic and can be by a certain amount or a randomly generated amount across the entire system for each application. Any exploits using these functions should become useless because they do not have any prior knowledge of the amount of memory allocations that are added or padded within the system. Generally exploits operate off of the premise that they understand the memory allocations that each application has where any error is within the application and how much space is available to overwrite for implementing an exploit. By padding each memory allocation, a potential exploit will become non-operational or interfere with other operations.

At step 806 the patching agent inserts one or more hooks to track heap allocations within the function. The hooks may provide or be used with a heap tracking agent. Step 706 is optional but can be used to gather additional information relating to potential exploits or vulnerabilities. The functions that are hooked may include, but are not limited to, “CreateFile (or NtCreateFile),” “OpenProcess,” “CreateProcess,” “VirtualProtect,” “VirtualAlloc,” “CreateThread”,” CreateFileMapping,” or the Nt equivalent. The Nt equivalents may be inside of ntdll.dll rather than kernel32.dll. In this manner, if an exploit tries to do anything these NOP detections may occur.

In one embodiment, the hooks inserted at step 806 can track heap allocations to detect non-operation (NOP) sleds in the heap memory. The heap tracking agent may track all heap allocations as well as addresses and sizes so that a function can be used to search for NOP sleds or the like. For example, a specific function can search for a NOP sled by checking at predefined points of a heap in memory. For example, the function can check at 25%, 50%, 75%, and 98% of a heap. The system may look for 0X90 NOP or “inc eax” 41, etc. for example. The system can check at any point in the heap but can use checks at less than all points of the heap to improve performance. In another example, the system checks a percentage of every heap that is allocated every time a special function is called. This can be implemented using a timer, can be inserted randomly within an application, or be performed during other protection mechanism functions as described herein.

At step 808 the patching agent inserts code into the application to increase the size of the stack allocations for memory stack instructions. In one example the memory stack is established in the assembly level instructions for an application. The patching agent accesses these instructions via assembly code and modifies the assembly code to increase the memory stack allocations. For example, the patching agent may generate an increased stack space 220 as shown in FIG. 11. In one example of step 808 the patching agent disassembles the assembly code for an application by searching the application for “push esp” and “move ebp, esp” assembly instructions in one embodiment. These assembly instructions generally occur in each application and are usually oriented at the top of the code. The patching agent may also search for each call instruction listed in the application by disassembling the application. The functions can then be checked for these instructions and the space following these instructions until a return. After finding each of the functions, the assembly code is modified by inserting code to increase the stack allocations. For example, the patching agent may examine the function for “sub esp, X” instructions which are used to decrease the stack and give space for function variables as well as the add “esp, X” instruction which will fix the stack space for whenever there is a return to the caller. By identifying each of these instructions the patching agent modifies both stack allocations related to these instructions, for example, by increasing the stack allocation.

At step 810, the patching agent optionally fills the stack allocation spaces with a cookie as shown in FIG. 13. The cookie can be generated randomly for each execution. In another example the cookie can be a static value or an irrelevant or null value.

At step 812 the patching agent inserts a call to a trampoline verification function that can verify the cookie inserted into the increased stack allocation space. The trampoline function is set up specifically for a function so that it can verify that the stack was not tampered with before a return. This can be performed before or after the stack's opposite “add esp, X” instruction. By increasing or modifying the stack allocation space the stack space is increased to a previously unknown and random size during operation. In this manner any potential exploits will crash or become non-operational because of the lack of understanding of the increase in stack space.

In one example the patching agent additionally performs other modifications to assembly code which uses the stack pointer. For example, if a program pushes a single argument to a function then in the assembly code it may include something such as esp-4. If the patching agent increases by 0X1000 (4096/1 page) then the patching agent can modify the assembly code to be esp-0X1004. The modification can be performed automatically. The patching agent may or may not modify other assembly code in the function based on whether or not the operand allows for a large stack difference. In another example, the patching agent determines how many arguments for monitoring pushes immediately before and copies them to the bottom of the stack.

In yet another option the patching agent creates a trampoline for each function. At the return the patching agent replaces the code with a call to a specific trampoline function. The trampoline functions understands the stack size (modified or not) which means the stack would work with or without the aforementioned cookie being inserted. The patching agent verifies that the stack has not been corrupted, overwritten or manipulated. This specific function can then compensate for the call by popping from the stack and then returning or executing the code that was overwritten to incorporate the call itself.

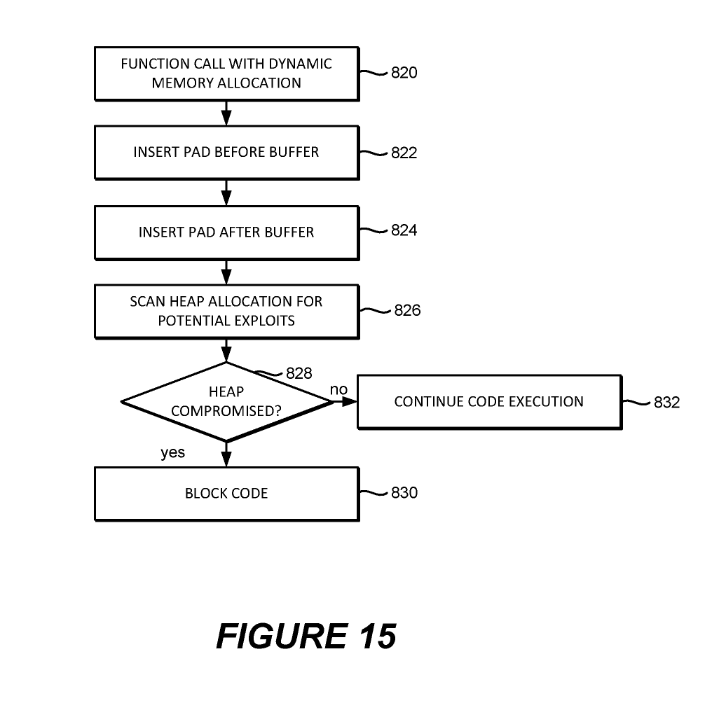

FIG. 15 is a flowchart describing operation of an application or other process modified according to the techniques of FIG. 14 in one embodiment. FIG. 15 specifically depicts execution of a process including modification for padding dynamic heap memory allocations. At step 820, a function is called that includes a dynamic memory allocation. The function at 820 will have been modified previously by the patching agent as shown in FIG. 14. The modified code may include a heap tracking agent. At step 822 the heap tracking agent inserts a pad before the buffer of the dynamic heap memory allocation. In one example the pad is a static size. In another the pad is a dynamically generated size. At step 824 the heap tracking agent inserts a pad after the buffer. In this manner, steps 822 and 824 dynamically alter the heap memory allocations so that any potential exploits will not have pre-determined knowledge of the memory size allocations.

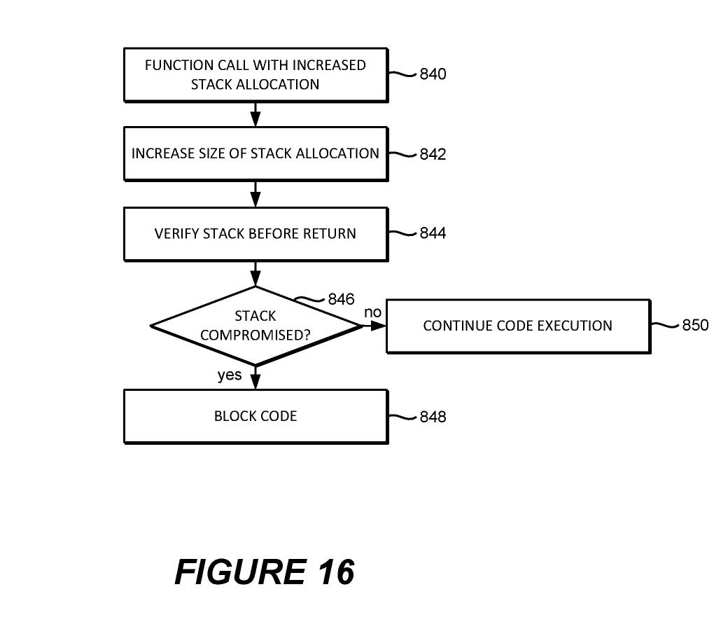

At step 826 the heap allocations for the function are scanned for potential exploits. In one embodiment, step 826 is performed in response to a hook that was inserted at step 806 of FIG. 16 to track heap allocations.

In one example, step 826 includes disassembling and checking the heap memory allocation. In another example, step 826 includes checking a portion of the heap allocation. For example the hook inserted as step 806 of FIG. 14 may search for a NOP sled or other exploit by checking at 25%, 50%, 75% and 98% of the heap allocation. The specific function can check for 0X90 NOP or other instructions that are indicative of a NOP sled as earlier described. If one of these addresses is detected, the heap tracking agent may examine the next address to determine if the same instruction has been inserted. After a threshold number of sequential memory locations include an instruction indicative of a NOP sled, the system can determine if the heap has been compromised.

At step 828, the heap tracking agent determines whether the heap has been compromised. If the heap has been compromised operation proceeds at step 830 where the code is blocked from further execution. If the heap has not been compromised code execution for the application is continued at step 832.

FIG. 16 is a flowchart describing operation of an application or process modified according to the patching agent as set forth in FIG. 14 in one example. FIG. 16 specifically depicts execution of a process including modification for padding a stack. At step 840 a function is called having a stack allocation modified previously by the patching agent. At step 842 the stack allocation in the function is increased in size. In one example, step 842 is performed automatically after the insertion of code at step 808 of FIG. 14 whenever the function is called at step 840.

At step 844, the stack tracking agent 222 verifies the stack before returning to the original application code. In one example, the patching agent inserts a cookie into the additionally allocated stack space from step 842 as described at step 810 of FIG. 14. The modified code calls a specific trampoline setup for the function. The specific trampoline verifies that the stack was not tampered with by determining whether the cookie read from memory matches the inserted value. If the modified code determines that the stacks have been compromised at step 846 it blocks the code from execution at step 848. If the modified code determines that the stack was not compromised the application code is allowed to continue executing at step 850.

In one embodiment, the patching agent is configured to insert a checking agent into functions that overwrite memory or that have been used in the past for exploits. For example, the checking agent may be inserted into functions such as “strcpy,” “memcpy,” “lstrcpy (win32api)” or other functions that overwrite memory. The checking agent can ensure that functions do not overwrite any addresses that are relative to heap/stack/vtable/etc. A list of relevant functions can be used. The checking agent can check the destination memory, as well as the source memory for these types of overwrites or overflows to ensure that heap allocations are overwritten or that an attack is writing to a memory address on the heap.

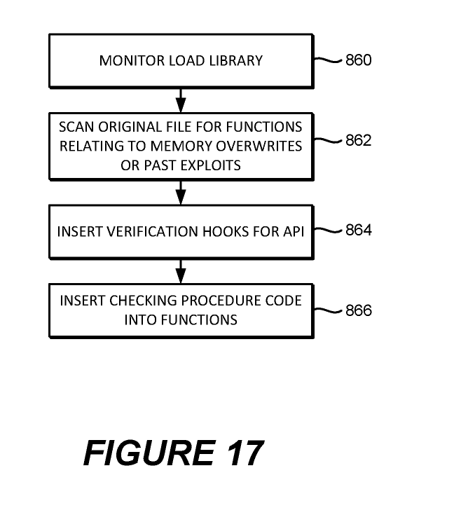

FIG. 17 is a flowchart describing a process of modifying an application's code (e.g., assembly code in memory) to provide a checking agent in accordance with one embodiment. At step 860, a patching agent or other software component or module monitors the load library. When an application or process is loaded, the patching agent scans the original code at step 862. The patching agent identifies any functions relating to memory overwrites or past exploits. At step 864, the patching agent inserts verification hooks for an API such as lstrcpy which can be loaded from a DLL. At step 866, the patching agent searches for the inline assembly code of all these function types (e.g., the compiler's assembly code for strcpy) and inserts a checking procedure to verify that the destination size doesn't overflow or allow the memory copy procedure to be used as an advantage for exploiting a machine or application.

It is noted that steps 864 and 866 need not be performed in every implementation. For example, step 864 can be used alone without step 866 in implementations to hook the API itself and thereby insert the checking agent. In another example, step 866 can be used alone without step 864 to insert the checking agent directly into the code as the checking procedure.

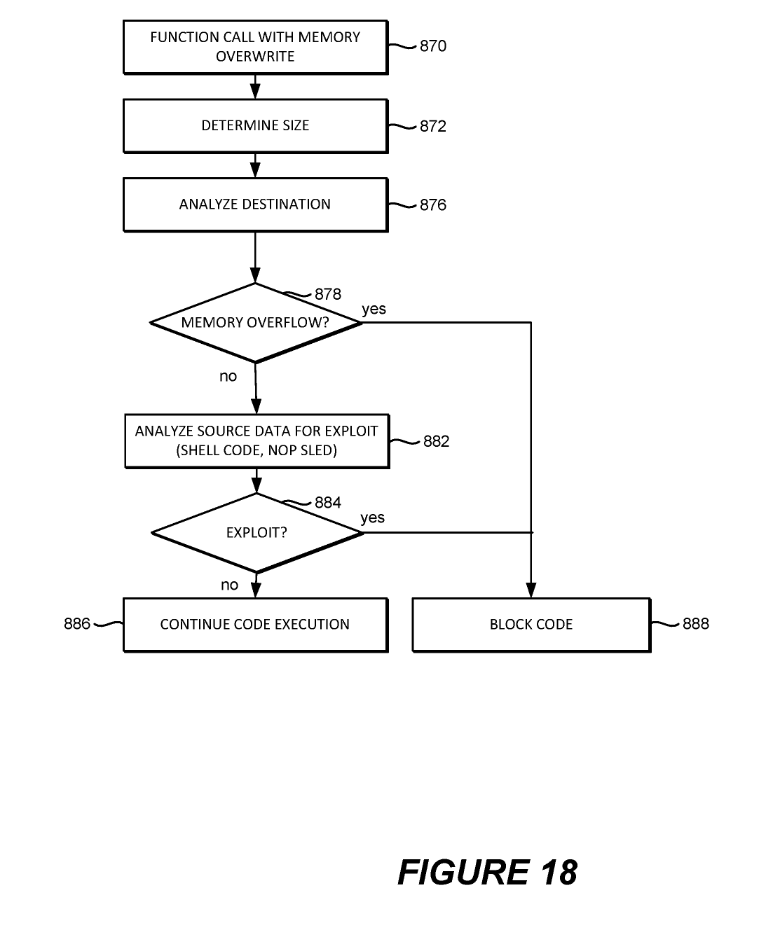

FIG. 18 is a flowchart describing operation of the checking agent in one embodiment. At step 870, an application issues a function call with a memory overwrite function. At step 872, the checking agent determines the size of the data this is going to overwrite the current memory contents. At step 876, the checking agent analyzes the destination for the memory overwrite. For example, the checking agent may access the ESP and EBP addresses (stack and frame buffer addresses). The checking agent utilizes the hooked heap allocation functions (e.g., step 806 of FIG. 16) to determine the base address of the ESP and EBP locations. The checking agent may utilize the hooked functions “Heap Alloc,” or “Global Alloc.”

At step 878, the checking agent determines if the function call will cause a memory overflow. The checking agent determines if the function call will overwrite the heap, the stack, Vtables, etc. The checking agent can use the base addresses from step 876 and compare them against the data that is being written to memory for the overwrite. If the data that is being written will cause a memory overflow, the code is blocked at step 888. For example, if there is a heap overflow the data will overwrite flink/blink so that when the memory gets deallocated, the checking agent can force the function to write a NULL byte at a specific location. This could be mitigated by taking the target address, and size and checking every byte/DWORD to verify that it doesn't fall within a range for a heap address, or a stack address.

If the function call does not appear to cause a memory overflow, the checking agent will analyze the source data for the memory overwrite at step 882. The checking agent can analyze the source data for any exploits such as shell code or NOP sleds.

The checking agent determines if any exploits were detected at step 884. If an exploit is detected the code is blocked from execution at step 888. If no exploits are detected, the code is allowed to execute at step 886.

In one embodiment, the patching agent is configured to implement a checking function for each call within code to identify and stop potential exploits. The patching agent is configured to redirect calls to trampoline functions which will increase the stack, pad, and push correct variables into the original function being called. The patching agent can insert into a thread specific array a trampoline's unique identifier. The original function can be called and then the stack is verified that it has not been corrupted. The thread's array can be verified against where it should be, and the previous calls by scanning the stack for the return address, which should correlate to the trampoline and unique ID. If something doesn't match or isn't returned, then the system determines that something has been compromised or attacked.

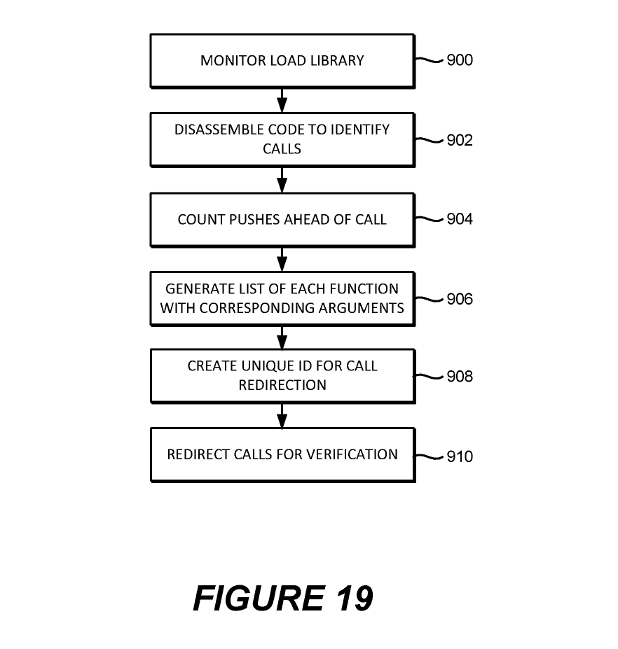

FIG. 19 is a flowchart describing a process of disassembling code to implement a checking function for individual calls in one embodiment. In one example, the checking function is implemented by a redirect verification agent 224. At step 900, the patching agent monitors the load library. When code is loaded, the patching agent disassembles the code to identify each call within the code at step 902. At step 904, the patching agent counts the number of push instructions before each call to determine if there are variables being passed using the stack rather than the registers. At step 906, the patching agent creates a list of each function and its corresponding arguments. At step 908, the patching agent creates a unique ID for each call of the function which is to be redirected. At step 910, the patching agent modifies the code to insert a verification agent that redirects each call for verification. The call redirection agent implements a trampoline function in one embodiment.

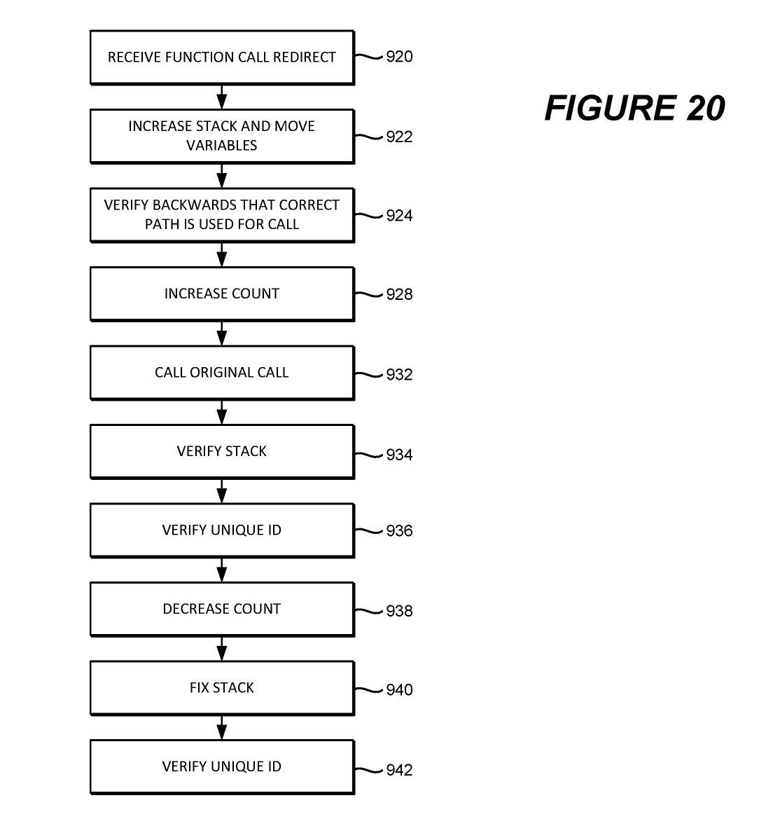

FIG. 20 is a flowchart describing the operation of the redirect verification agent 624 in one embodiment. At step 920, the verification agent receives a function call redirect as a result of the code modification in FIG. 19. At step 922, the verification agent increases the stack and moves the variables which were going to be for the original function to the lowest point of the stack. In one embodiment, the lowest point of the stack is the end of the padding or the increased stack size from step 842 of FIG. 16. The verification agent can optionally insert a cookie in the stack at step 922.

At step 824, the verification agent verifies backwards that the correct path is used for the call. Because the verification agent knows the address of each call redirection (e.g., trampoline), it can track the stack and verify the unique IDs that were returned. For example, the verification agent can look backwards on the stack to find the most recent call. The verification agent verifies whether the correct unique IDs were returned. The verification agent can determine whether the most recent call matches the unique ID for the call redirection or trampoline. If the call does not match the unique ID, the verification agent determines that something has been redirected by exploit, attack, or bug. The verification agent blocks the code from execution in one embodiment if the call does not match the function ID.

At step 928, the verification agent increases a count for the thread. This current count is where the verification agent puts the unique ID for a specific call redirection. At step 932, the verification agent calls the original call, whether it's a normal direct call or a pointer call. At step 934, the verification agent verifies whether the stack has been corrupted. If the stack has been corrupted, the verification agent can block execution of the code.

At step 936, the verification agent verifies the unique ID against the current ID at the count. If the ID's do not match, the verification agent can block execution of the code. At step 938, the verification agent decreases the count. At step 940, the verification agent fixes the stack. The verification agent can determine if any of the variables were changed. If a variable was changed, the verification agent moves it to where it should be by replacing the original variables that were pushed, or determined to be used with the memory from the end of the padding. At step 942, the verification agent optionally verifies the unique ID against the current ID at the count. After verifying the unique ID, the verification agent can return so that the original code is executed as if the redirection never took place.

In one embodiment, another function is inserted or called during the call redirection of FIG. 20. The function takes a section of space for every thread and allocates space for a fixed (e.g., 2048) or arbitrary count array and two variables to be used as the count described above. The function is thread specific, and therefore may use “TlsAlloc” or have the memory allocated on initial modification during execution if done in memory only. If the count goes above the arbitrary set space for the thread then an “overflow count” exists so whenever the thread sets the unique ID at the array it will modular the count so variable (count%total_count) will equal the unique ID. This overflow will not decrease unless the count goes below it. This can ensure that when the unique IDs are verified anything below the overflow can be ignored if more than the arbitrary number of calls in a row happen. If the count is below it after doing the module count%total_count they should not be ignored when verifying the unique IDs. Nevertheless, if the count is 50 for example, and the overflow is 5, and something between 5 and 560 goes wrong, the verification agent will know that something broke, for instance. The overflow would go back to 0 whenever the count is 0 and it is overwritten. This array could also be matched against a structure which will contain {unique ID, call redirection (trampoline) return address (from the call), and stack size being increased]. This can enable optimization of speed of scanning backwards on the stack to verify that everything is validated. This can be used in an algorithm for taking ESP (stack pointer) and calculating exactly where to expect the correct address for a unique ID. The structure can be generated on initial generation of the call redirections.

Because the address of every call redirection or trampoline for each call is known, the stack can be traced to verify that the correct unique IDs were returned. The verification agent can look backwards on the stack to identify the most recent call. If the most recent call does not match the unique ID for the corresponding call redirection or trampoline, the verification agent can determine that something has been redirected by exploit, attack, or bug. This can be done before or after the count is increased. By hooking various OS API's or redirecting the calls, it can be detected whether a specific call did or did not return to the call to which it was supposed to return. If the call does not return to the expected location, the verification agent can determine that there has been an attack, etc.

These locations may also be placed to integrate other security checks such as ROP mitigation, Heap validation, etc. This can be performed on every call or specific calls determined by an algorithm. Randomization can also be used for picking or some that are absolute can be used (e.g., the most used API for exploits).

In one embodiment, the patching agent is configured to implement a call list agent for applications. Scenarios that call outside functions can be found by disassembly or using an Import Address Table (DLLs where functions are being imported). A list of the calling function addresses is created so that each function can be hooked to ensure that the calling address was previously listed on application execution so that it can be known if it is being called from shellcode or ROP. Each function can be hooked using a trampoline, or by replicating the import address table with trampolines and then jumping to the original function.

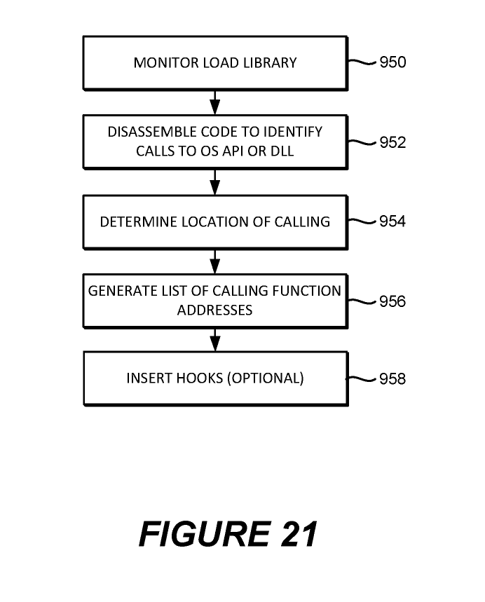

FIG. 21 is a flowchart describing a process of disassembling code to implement a call list agent for an application. At step 950, the patching agent monitors the load library. When an application is loaded, the patching agent identifies each call within the code to an operating system (OS) API or DLL at step 952. Step 952 may be performed using a disassembler when the code is loaded into memory. The patching agent can disassemble the code or analyze calls using the Import Address Table (DLLs where functions are being imported).

At step 954, the patching agent determines each location within the application that calls a function. At step 956, the patching agent generates a list or array including the addresses for each calling function. If functions are loaded dynamically by “LoadLibrary” for example, the patching agent can keep track by hooking “GetProcAddress” and monitoring what is calling the function that is in turn calling “GetProcAdress.”

At step 958, the patching agent optionally inserts hooks into the OS API's to ensure that the function calling the API was in fact meant to call that API. The hooks can be trampoline functions in one embodiment or can be created by creating a new import address table which will comprise trampolines to all of the original functions.

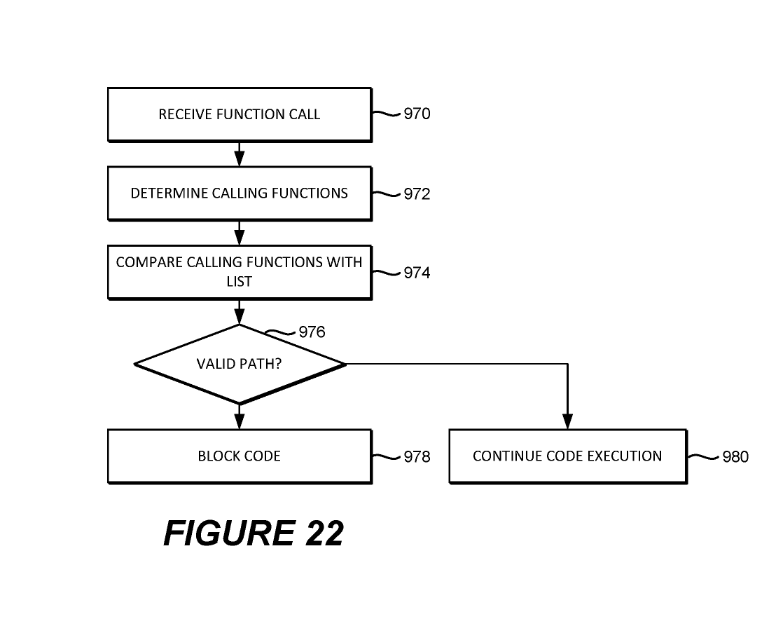

FIG. 22 is a flowchart describing the operation of the call list agent in one embodiment. At step 970, the call list agent receives a function call from an application. At step 972, the call list agent determines the calling functions. Step 972 includes determining the immediate function that issued the call to the API or DLL, as well as tracking backwards through the entire path of function calls that eventually resulted in the call to the specific function that was hooked.

At step 974, the call list agent compares the calling functions with the list. At step 976, the call list agent determines whether the calling path is valid. The call list agent ensures that the each calling function (e.g., verified by ESP so the calling functions return address) is listed as within one of the functions/address areas/locations found earlier on initial load. The call list agent verifies that each call happened the way that is should according to the earlier created list. In this manner, if an exploit calls a function directly through shellcode or ROP, for example, the call list agent will immediately determine that the return address is not within a specific memory region that was found initially. If the call list agent determines that the path is not valid, the code is blocked from being executed at step 978. If the call list agent determines that the path is valid, the code is allowed to execute at step 980.

The foregoing detailed description has been presented for purposes of illustration and description. It is not intended to be exhaustive or to limit the invention to the precise form disclosed. Many modifications and variations are possible in light of the above teachings. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A computer-implemented method, comprising:
identifying a plurality of software modules in a computing system in response to a process event;
determining a thread start address for a first thread corresponding to the process event;
determining whether the first thread is associated with one or more software modules of the plurality based on the thread start address; and
generating a security event if the first thread is not associated with the one or more software modules.

2. The computer-implemented method of claim 1, further comprising:
receiving a process event notification from a first process indicating the process event, the first process including the first thread.

3. The computer-implemented method of claim 2, wherein:
determining the thread start address comprises querying an operating system of the computing system to determine the thread start address of the first thread.

4. The computer-implemented method of claim 3, wherein:
determining whether the first thread is associated with one of more software modules of the plurality comprises determining whether the thread start address is within an address range of the plurality of software modules.

5. The method of claim 4, further comprising:
identifying a first software module from the plurality of software modules associated with the first process based on the thread start address;
determining whether the first software module is listed as a legitimate software module; and
generating a security event if the first module is not listed as a legitimate software module.

6. The computer-implemented method of claim 5, wherein:
the plurality of software modules is a plurality of shared libraries; and
identifying the plurality of software modules comprises enumerating the plurality of shared libraries.

7. The method of claim 6, wherein:
the event notification is a call received from the first process to trigger determining the thread start address.

8. The computer-implemented method of claim 1, further comprising:
loading a security agent into a first process upon execution of the first process; and
generating a process event notification by the security agent in response to a thread attach event associated with the first thread.

9. The computer-implemented method of claim 8, wherein:
loading the security agent into the first process comprises compiling the security agent as a library and inserting the library into the first process.

10. The computer-implemented method of claim 1, further comprising:
forcibly injecting a security agent into a first process associated with the first thread upon execution of the first process; and
generating a process event notification by the security agent in response to a thread attach event associated with the first thread.

11. The computer-implemented method of claim 10, wherein:
forcibly injecting the security agent comprises injecting the security agent in the first process through a debugging application programming interface.

12. The computer-implemented method of claim 10, wherein:
forcibly injecting the security agent comprises injecting the security agent in the first process through a kernel of the operating system.

13. A computer-implemented method, comprising:
in response to a process event, determining in a memory a first base address of a first code segment;
loading in the first memory at a second base address a second code segment corresponding to the first code segment;
modifying the second code segment based on the first base address;
comparing the second code segment to the first code segment after modifying the second code segment; and
generating a security event if the first code segment does not match the second code segment.

14. The computer-implemented method of claim 13, modifying the second code segment comprises:
applying relocations to one or more instructions in the second code segment based on the first base address.

15. The computer-implemented method of claim 14, wherein:
comparing the second code segment with the first code segment comprises performing a binary comparison of the first code segment and the second code segment.

16. The computer-implemented method of claim 14, wherein:
comparing the second code segment with the first code segment comprises performing a checksum on the first code segment and the second code segment.

17. The computer-implemented method of claim 13, further comprising:
generating the security event in response to a failure to load the second code segment.

18. The computer-implemented method of claim 13, further comprising:
identifying a first process associated with a first thread in response to an event notification for the process event, the first process being associated with a first copy of a file in the memory including the first code segment;
identifying in a second memory the file; and
wherein loading in the first memory comprises loading a second copy of the file in the first memory at the second base address.

19. A computer-implemented method, comprising:
in response to an event notification associated with a first thread, determining a thread start address for the first thread;
determining one or more stack addresses allocated for the first thread by an operating system;
determining whether the thread start address is within the one or more stack addresses allocated for the first thread; and
generating a security event if the thread start address is not within the one or more stack addresses allocated for the first thread.

20. The computer-implemented method of claim 19, further comprising:
determining whether a stack pointer is within the one or more stack addresses allocated for the first thread; and
generating a security event if the stack pointer is not within the one or more stack addresses.

21. The computer-implemented method of claim 19, further comprising:
in response to the event notification, identifying one or more calling functions associated with the first thread;
loading into a memory a second copy of the one or more calling functions associated with the first thread;
comparing the second copy of the one or more calling functions with a first copy of the one or more calling functions existing in the memory; and
generating a security event if the second copy and the first copy do not match.

22. The computer-implemented method of claim 19, wherein the event notification is a first event notification, the method further comprising:
in response to a second event notification associated with the first thread, allowing execution of the first thread without determining a thread start address for the first thread.

23. The computer-implemented method of claim 22, further comprising:
determining a first rating associated with the first event notification and a second rating associated with the second event notification.

24. A computer-implemented method, comprising:
in response to a process event associated with a first thread, determining a thread start address for the first thread;
determining a first execution path of the first thread based on the thread start address;
comparing the first execution path with a plurality of predefined execution paths for an application associated with the first thread; and
generating a security event if the first execution path does not match at least one of the predefined execution paths for the application.

25. The computer-implemented method of claim 24, further comprising:
analyzing the application during a training mode to define the plurality of predefined execution paths.

26. The computer-implemented method of claim 24, further comprising:
updating a list of the plurality of predefined execution paths based on at least one system call to an operating system.

27. The computer-implemented method of claim 24, wherein the process event is a first process event, the method further comprising:
in response to a second process event associated with the first thread, allowing execution of the first thread without comparing the first thread with the plurality of predefined execution paths.

28. The computer-implemented method of claim 27, further comprising:
determining that the first process event is associated with a predefined set of operating system functions being called by one or more addresses; and
determining that the second process event is not associated with the predefined set of operating system functions.

29. The computer-implemented method of claim 24, wherein:
the process event is a trigger from an operating system associated with the first thread.

30. The computer-implemented method of claim 24, further comprising:
attaching one or more debuggers to a plurality of processes associated with an operating system;
modifying the plurality of processes to include a plurality of hooks; and
receiving an event notification corresponding to the process event in response to execution of one or more of the plurality of hooks.

31. The computer-implemented method of claim 24, wherein:
the plurality of predefined execution paths are for an application associated with the first thread.

32. An apparatus, comprising:
a central processing unit;
a memory coupled to the central processing unit, the memory configured to store a plurality of processes for execution by the central processing unit; and
a security circuit coupled to the memory and the central processing unit, the security circuit is configured to access a plurality of instructions associated with a first process and compare an execution path associated with the plurality of instructions with a plurality of predefined executions paths for the first process, the security circuit is configured to block execution of the plurality of instructions in response to the execution path not matching at least one of the predefined execution paths.

33. The apparatus of claim 32, wherein:
the security circuit comprises a random access memory module; and
the random access memory module is configured to block the central processing unit from retrieving the plurality of instructions in response to the execution path not matching at least one of the predefined execution paths.

34. The apparatus of claim 32, wherein:
the security circuit is configured to receive from an operating system executed by the central processing unit an identification of a plurality of software modules associated with the operating system;
the security circuit is configured to verify that that the plurality of instructions are associated with at least one of the software modules;
the security circuit is configured to block execution of the plurality of instructions in response to a failure to verify that the plurality of instructions are associated with at least one of the software modules.
